(19) United States
(12) Patent Application Publication
(10) Pub. No.: US 2026/0288743 A1
(43) Pub. Date: Sep. 24, 2026

(54) SYSTEM

(71) Applicant: SoftBank Group Corp., Tokyo (JP)

(72) Inventor: Koji MATSUDA, Tokyo (JP)

(73) Assignee: SoftBank Group Corp., Tokyo (JP)

(21) Appl. No.: 19/567,018

(22) Filed: Mar. 14, 2026

(30) Foreign Application Priority Data
Mar. 19, 2025 (JP) 2025-045062

(51) Int. Cl. G06F 16/248; G06F 16/242; G06F 16/2457

(52) U.S. Cl. CPC G06F 16/248; G06F 16/243; G06F 16/24578

(57) ABSTRACT

A system includes a processor that is configured to receive a text posted to an information medium, generate a prompt sentence for instructing analysis of the received text to identify information requiring fact checking, input the generated prompt sentence into a generative artificial intelligence model to automatically extract the information requiring fact checking, generate a search query using the extracted information and perform an information search, and present search results to a user.

### CROSS-REFERENCE TO RELATED APPLICATION

This application is based on and claims priority under 35 USC 119 from Japanese Patent Application No. 2025-045062 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional fact-checking of textual content posted on various information media, such as news websites, social media platforms, and online forums, largely relies on manual work performed by human editors or fact-checkers. Manual identification of statements that require fact checking is time-consuming and inefficient, especially when a large volume of text is continuously posted. In addition, when a user attempts to verify factual information, the user must independently formulate appropriate search queries, perform web searches, and manually examine multiple search results in order to determine the correctness of each statement. This workflow imposes a significant cognitive load on the user and often results in inconsistent or incomplete verification.

Furthermore, existing automated or semi-automated tools for text analysis generally focus on simple keyword extraction or rule-based pattern matching, and therefore lack the ability to flexibly identify nuanced or context-dependent factual claims that require verification. As a result, many important claims remain unchecked, while non-critical information may be unnecessarily flagged, thereby reducing the efficiency and reliability of the overall fact-checking process.

Accordingly, there is a need for a system that can automatically identify information requiring fact checking from text posted to an information medium, automatically generate appropriate search queries based on such information, perform information searches, and present search results to a user in a manner that facilitates efficient and accurate verification of factual statements.

### SUMMARY

To solve the above-described problems, a system is provided comprising a processor, wherein the processor is configured to receive a text posted to an information medium, generate a prompt sentence for instructing analysis of the received text to identify information requiring fact checking, input the generated prompt sentence into a generative artificial intelligence model to automatically extract the information requiring fact checking, generate a search query using the extracted information and perform an information search, and present search results to a user.

In one aspect, the processor is configured to use natural language processing techniques to analyze a context of the text and generate the prompt sentence for instructing identification of the information requiring fact checking. By analyzing contextual relationships, entities, numerical values, and temporal expressions contained in the text, the processor generates a prompt sentence that effectively guides the generative artificial intelligence model to extract statements that are likely to be factual claims requiring verification.

In another aspect, the processor is configured to display the search results acquired through a user interface in a format that is easily understandable to the user. For example, the processor may group search results by corresponding extracted information, present titles, URLs, and summary snippets of retrieved documents, and visually associate each extracted factual claim with its relevant search results. Through these means, the system enables a user to quickly grasp the external information related to each factual claim and to efficiently determine the correctness of the information contained in the original text.

The term “system” refers to a combination of one or more hardware and/or software components that cooperate to perform the processing defined in the claims, including at least a processor and associated memory, and optionally network interfaces, storage devices, and user interface devices.

The term “processor” refers to any hardware circuitry, such as a central processing unit (CPU), graphics processing unit (GPU), application-specific integrated circuit (ASIC), field-programmable gate array (FPGA), or a combination thereof, configured to execute instructions to perform the operations recited in the claims.

The term “information medium” refers to any electronic platform or service capable of receiving, storing, or distributing text posted by users, including but not limited to websites, news portals, social media platforms, bulletin board systems, blogs, and online forums.

The term “text” refers to a sequence of characters or words expressed in a natural language, including sentences, paragraphs, articles, posts, comments, or any other linguistic content that can be processed by the system.

The term “prompt sentence” refers to a text string generated by the processor and provided as input to a generative artificial intelligence model, the text string instructing the model how to analyze the received text and what type of information to identify or extract.

The term “generative artificial intelligence model” refers to a machine learning model trained to generate or transform text based on input data, including but not limited to large language models, transformer-based models, and other neural network models capable of producing textual output in response to prompts.

The term “information requiring fact checking” refers to one or more portions of the text, such as statements, claims, or expressions, that describe factual content, including numerical values, dates, events, entities, or relationships, and that are determined to be candidates for verification against external information sources.

The term “automatically extract” refers to the operation in which the generative artificial intelligence model, without manual selection by a user for each instance, identifies and outputs information requiring fact checking from the received text in response to the prompt sentence.

The term “search query” refers to a text string or structured query generated by the processor based on the extracted information, the text string or structured query being suitable for submission to an information retrieval system or search engine in order to obtain relevant search results.

The term “information search” refers to a process in which the processor submits one or more search queries to a search engine, database, or other information retrieval system and obtains corresponding search results related to the extracted information.

The term “search results” refers to data returned from an information search in response to a search query, including but not limited to document titles, URLs, snippets, summaries, metadata, or full-text records that are relevant to the extracted information.

The term “user” refers to any human operator who interacts with the system through a user interface, including but not limited to editors, proofreaders, journalists, moderators, or general end-users who review or verify factual information.

The term “user interface” refers to any hardware and/or software mechanism by which the user interacts with the system, including graphical user interfaces, web interfaces, mobile application interfaces, command-line interfaces, and display devices combined with input devices such as keyboards, mice, or touchscreens.

The term “display” refers to the act performed by the processor of causing visual information, such as search results or extracted information, to be presented on a screen or other output device in a human-readable format.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

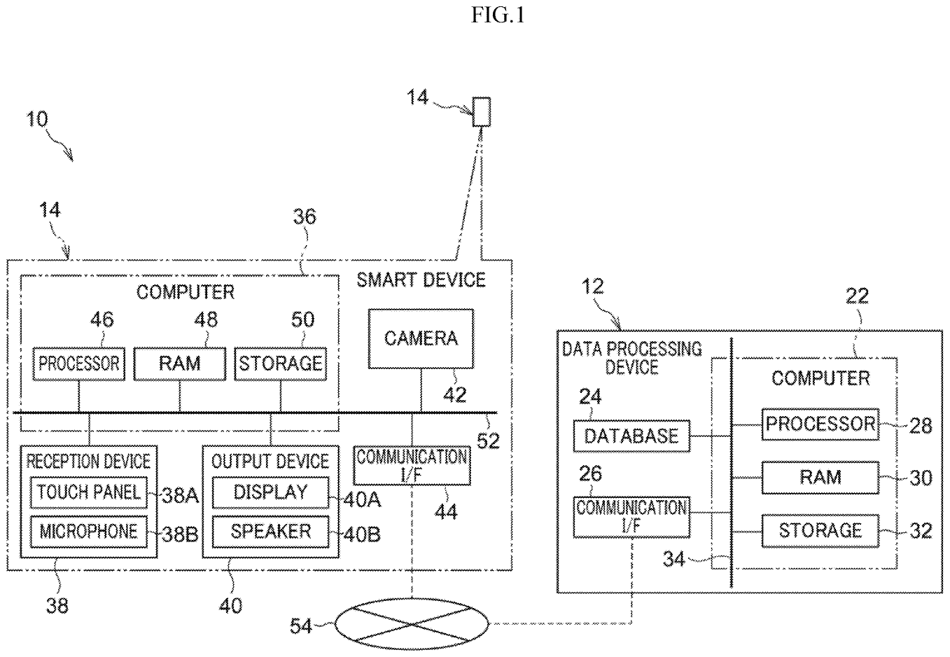

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

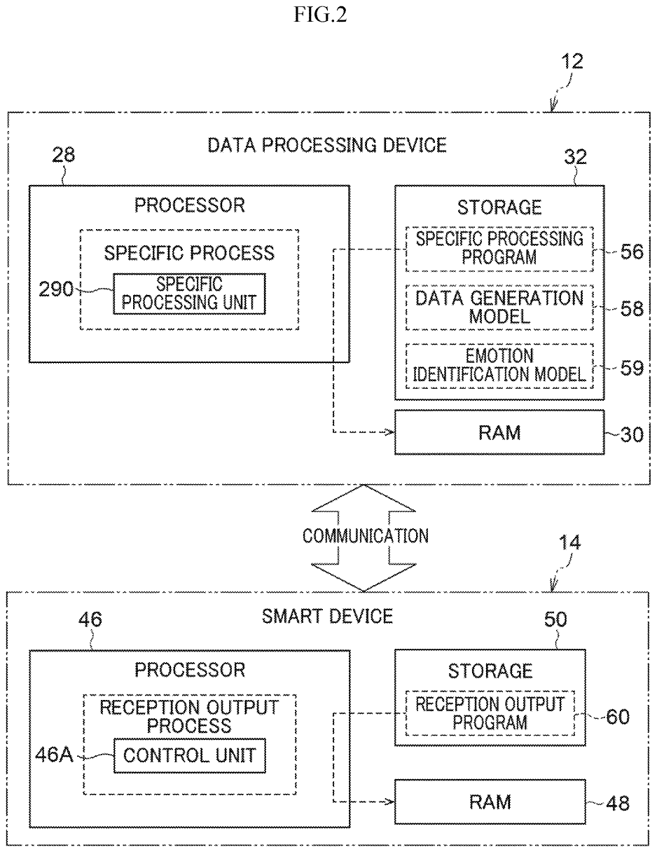

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like).

Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional fact-checking support systems suffer from significant technical limitations in how textual information is processed, how search queries are generated, and how user feedback is utilized. In many existing systems, the server simply receives user-submitted text and forwards either the raw text or simplistic keyword extractions to an external search engine. Such systems often rely on fixed rule sets or static templates to identify factual statements and to construct search queries. As a result, the server performs only shallow text handling and does not effectively leverage modern machine learning techniques to optimize intermediate representations of the text. This leads to technically suboptimal usage of computing resources, including unnecessary network traffic, redundant searches, and low-quality retrieval results that must be manually filtered by the user.

In particular, the generation of search queries from user text is frequently handled through basic string matching or hand-crafted heuristics. These approaches do not use contextual understanding of the text and tend to produce noisy or incomplete queries. Consequently, when the server issues such queries to an external search platform, the returned search results are often irrelevant or lack sufficient coverage of the factual aspects that actually require verification. This degrades the overall performance of the information processing pipeline, increases the computational cost associated with repeated or refined searches, and burdens the user with additional manual steps to locate authoritative sources.

Moreover, conventional systems do not fully exploit generative artificial intelligence models within the core infrastructure of the server. In many configurations, generative models are used only at the presentation layer, for example, to summarize results, without integrating the generative model into the earlier stages of fact extraction or query construction. This underutilization prevents the server from achieving deeper semantic analysis and from dynamically adapting its query generation strategy to the characteristics of the input text. As a result, system throughput, accuracy of retrieved information, and robustness across diverse content domains remain limited.

Additionally, user feedback regarding the correctness or usefulness of search results is often not captured or, if captured, is not systematically integrated back into the internal models or processing pipelines. Without structured feedback that is linked to specific extracted facts and specific retrieved items, the server cannot effectively refine its models for candidate fact extraction or result ranking. This omission leads to persistent inefficiencies, as the system repeatedly applies the same extraction and retrieval logic even when user interactions indicate recurring patterns of error or irrelevance.

Accordingly, there is a need for an improved computerized fact-checking support system in which a processor on a server is specifically configured to: (i) generate prompt sentences that direct a generative model to identify candidate information requiring fact checking; (ii) use the generative model to automatically extract such candidate information and to generate optimized search strings representing the factual content to be verified; (iii) associate retrieved related information with individual extracted facts to produce structured display data that can be efficiently processed and understood; and (iv) capture and store user evaluations in association with fact identifiers and result identifiers so that this feedback can be reused as learning data to improve subsequent extraction and retrieval operations. By architecting the system around these technical features, the invention aims to improve the functioning of the computer system itself, including more efficient use of processor, memory, and network resources, as well as higher precision and recall in the automated retrieval of verification sources.

The specific processing by the specific processing unit 290 of the data processing device 12 in Example 1 is realized by the following means.

The present invention provides a server comprising a processor configured to receive character information posted on an information distribution platform; analyze the received character information and generate a prompt sentence including instruction content for extracting candidate information that includes content requiring fact checking; input the prompt sentence into a generative information processing model and automatically extract information requiring fact checking corresponding to the candidate information; generate, based on the extracted information, a search character string representing a fact to be verified; transmit the search character string to an external information search platform and execute an acquisition process for related information; aggregate the acquired related information in association with the extracted information and generate display data structured so that a user can evaluate correctness of the fact; present the display data via a user interface; automatically generate the prompt sentence including the instruction content for extracting the candidate information and the search character string based on a response generated by the generative information processing model; instruct the generative information processing model to generate at least elements of the candidate information, search conditions, and a summary for explanation to the user; manage identification information indicating a correspondence between the information requiring fact checking extracted from the character information and the related information; record an evaluation result of the user input via the user interface in association with the identification information; and use recorded content as learning data for updating at least one of an extraction process of the candidate information and an acquisition process of the related information. This enables the server to perform deeper, model-driven text analysis and query generation, to issue more contextually appropriate search requests with reduced redundancy, to structure retrieved results in a manner that lowers the cognitive and operational load on the user, and to iteratively improve internal extraction and retrieval algorithms based on accumulated user feedback, thereby improving the overall efficiency, accuracy, and technical performance of the fact-checking support system.

The term “system” refers to a combination of one or more hardware devices and software components that cooperate to perform information processing, including at least one processor and associated memory, communication, and input/output resources.

The term “processor” refers to one or more hardware-based processing units, such as a central processing unit or a graphics processing unit, capable of executing instructions to perform data processing operations.

The term “character information” refers to digital text data composed of encoded characters, including letters, numerals, symbols, and punctuation, which is stored, transmitted, or processed by a computer system.

The term “information distribution platform” refers to an electronic service or infrastructure that allows users or systems to post, distribute, or access digital content, including text, through a communication network.

The term “prompt sentence” refers to a sequence of characters or text that includes instructions or guidance provided as an input to a generative information processing model in order to cause the model to perform a specific task.

The term “instruction content” refers to semantic information contained in the prompt sentence that specifies what operation the generative information processing model should perform, such as extracting candidate information or generating a search string.

The term “candidate information” refers to a portion of character information that has been identified as a potential factual statement or data element that may require verification by further processing.

The term “content requiring fact checking” refers to information within the character information that represents a factual assertion, numerical value, time, location, or other verifiable element whose correctness is intended to be confirmed.

The term “generative information processing model” refers to a machine learning model, such as a neural network, configured to generate text or other data outputs in response to input data, including prompt sentences.

The term “information requiring fact checking” refers to extracted factual elements, derived from candidate information, that are identified as targets for verification against external information sources.

The term “search character string” refers to a sequence of characters, such as a keyword string or query text, that is constructed for submission to an information search system in order to retrieve related information.

The term “fact to be verified” refers to the semantic content of a factual assertion represented by extracted information, for which the system attempts to obtain corroborating or refuting information from external sources.

The term “external information search platform” refers to a remote computing service or system that provides search functionality over one or more data collections, including network-based document repositories or databases.

The term “acquisition process for related information” refers to a sequence of operations in which the system submits a search character string to the external information search platform and receives, parses, and stores search results that are relevant to the fact to be verified.

The term “related information” refers to information items, such as documents, snippets, metadata, or structured records, obtained from the external information search platform that are associated with or pertinent to the information requiring fact checking.

The term “aggregate” refers to the operation of collecting multiple pieces of related information and organizing them into a combined structure according to predefined associations or identifiers.

The term “display data” refers to structured data that has been formatted or organized so that it can be rendered on a user interface for human perception and interaction.

The term “user” refers to a human operator who interacts with the system through a user interface to initiate fact-checking processes, review results, and provide evaluations or feedback.

The term “user interface” refers to a hardware and software arrangement, such as a graphical user interface or web interface, that allows a user to input commands and data and to receive information presented by the system.

The term “elements of the candidate information” refers to component parts of the candidate information, such as entities, numerical values, temporal expressions, or relational phrases, that are individually identifiable and can be used in further processing.

The term “search conditions” refers to parameters or constraints used in addition to or in combination with a search character string, such as time ranges, domains, languages, or filters that influence the behavior of the external information search platform.

The term “summary for explanation to the user” refers to a condensed textual description generated by the system or the generative information processing model that explains, in human-readable form, what content is being verified or what the search results represent.

The term “identification information” refers to data, such as an identifier or key, that uniquely indicates a specific piece of information requiring fact checking, a specific related information item, or an association between them.

The term “correspondence” refers to a definable relationship or mapping between two or more data items, such as an extracted fact and one or more related information items obtained from a search.

The term “evaluation result of the user” refers to feedback data indicating the user's assessment of correctness, reliability, relevance, or usefulness of the information requiring fact checking or the related information.

The term “recorded content” refers to data stored by the system that includes at least the evaluation result of the user and associated identification information.

The term “learning data” refers to data used to train, fine-tune, or adjust one or more models or algorithms, including machine learning models, that are employed in the extraction process of candidate information or the acquisition process of related information.

The term “extraction process of the candidate information” refers to a set of computational steps that analyze character information, identify portions that may contain factual assertions, and produce candidate information as an output.

The term “acquisition process of the related information” refers to a set of computational steps that generate search character strings, interact with an external information search platform, and obtain and process related information corresponding to extracted facts.

In one embodiment, a server is implemented as a network-connected computing device including at least one processor, a main memory, a non-volatile storage unit, and a network interface. The server executes an operating system such as a server-class operating system and runs an application framework such as a web application framework written in a high-level programming language. The server further executes natural language processing libraries such as a syntactic and named-entity analysis library (for example, a library of the spaCy type) and a contextual language representation model of the transformer type (for example, a BERT-type model implemented using a deep-learning framework such as PyTorch). The server is also configured to access a generative AI model, such as a large language model of the transformer type, via an application programming interface provided by an external model-hosting service or by a local model-serving process.

The server stores character information, intermediate analysis results, and search results in structured data formats in a storage system such as a relational database system and, optionally, an in-memory key-value store. The server defines internal data structures where each textual input is associated with a session identifier, a list of sentences, a list of candidate information items, a list of search character strings, and a list of related information records. Each candidate information item includes at least a sentence string, positions of tokens in the sentence, and a set of features such as named entities, numerical values, temporal expressions, and a classification score indicating a likelihood that the sentence represents content requiring fact checking.

The terminal is implemented as a client computing device such as a desktop computer, a notebook computer, a smartphone, or a tablet. The terminal executes a web browser or a native client application that provides a graphical user interface. The terminal includes a display, an input device such as a touchscreen, keyboard, or pointing device, a local processor, and local memory. The terminal communicates with the server via a communication network using a communication protocol such as HTTPS.

The user operates the terminal to supply character information that is to be checked. The user pastes or types text into an input control, or uploads a document that contains character information, and instructs the terminal to send the character information to the server. The user later reviews fact-checking results presented by the terminal, selects specific related information items such as links to external resources, and provides explicit evaluation information such as confirmation or rejection of specific facts.

The server receives character information from the terminal and stores the received character information in the storage system together with a session identifier. The server normalizes the character information by converting it to a predetermined character encoding such as UTF-8 and by standardizing line breaks and whitespace. The server then segments the normalized character information into sentences using the syntactic analysis library. The segmentation process uses statistical models and rule-based patterns executed within the library to place sentence boundaries in the character sequence and to label each resulting segment as a sentence unit.

The server performs linguistic analysis on each sentence. The server uses the syntactic analysis library to perform tokenization, part-of-speech tagging, dependency parsing, and named entity recognition. The server thereby converts each sentence into a structured representation comprising tokens, grammatical relationships, and entity labels. The server then forwards tokenized sentences to a contextual representation model of the BERT type, which is implemented as a multi-layer bidirectional transformer neural network. The BERT-type model uses a multi-head self-attention mechanism and feed-forward sublayers to encode each token into a contextual embedding vector in a high-dimensional continuous space. The server uses these embedding vectors as numerical feature representations that capture semantic and syntactic context for each token and for entire sentences.

The server applies a classification module to determine whether each sentence or clause contains candidate information that represents content requiring fact checking. In one embodiment, the classification module is implemented as a neural network classifier that takes as input a pooled sentence embedding vector derived from the BERT-type model. The classifier includes at least one fully connected layer and an activation function such as a rectified linear unit. The server computes an output score representing the probability that the sentence corresponds to a factual assertion. The server compares the output score with a predefined threshold to determine whether the sentence is candidate information. By using dense contextual embeddings and a trained classifier, the server is able to distinguish factual assertions from purely subjective or rhetorical text with higher precision and recall than simple keyword-based methods.

The server further refines candidate information by combining linguistic features from the syntactic analysis and contextual features from the transformer model. The server identifies entities such as locations, organizations, dates, quantities, and events in each candidate sentence, and groups these entities into structured tuples that represent specific facts. For example, the server can produce an internal representation for a sentence such as “The number of new COVID-19 cases in Tokyo exceeded 1000 yesterday,” in which the server identifies “Tokyo” as a location entity, “COVID-19 cases” as a subject entity, “1000” as a quantity, and “yesterday” as a time expression. The server stores these tuples in association with the candidate sentence and the session identifier.

The server uses a generative AI model to transform candidate information into optimized prompt sentences and search character strings. The server constructs a prompt sentence that provides the generative AI model with instruction content and context. For example, the server can construct a prompt sentence of the following form:
“Given the factual claim: ‘The number of new COVID-19 cases in Tokyo exceeded 1000 yesterday,’ output a concise search query suitable for a web search engine to verify this claim. Only output the query.”

The server sends such a prompt sentence to the generative AI model using a model-access interface. The generative AI model is, in one embodiment, a transformer-based language model comprising multiple attention layers, feed-forward layers, and normalization layers, trained on a large corpus of text. The server receives a generated response from the generative AI model, which is a search character string, for example:
“Tokyo COVID-19 new cases yesterday number official report”.

The server then sanitizes and possibly truncates this generated search character string to conform to length and character constraints of external search platforms. By delegating the optimization of search character strings to a generative AI model that is conditioned on rich contextual candidate representations, the server improves the relevance and coverage of retrieved results, thereby reducing the need for repeated or manual query reformulation and reducing the number of network requests required to obtain suitable related information.

The server may also use the generative AI model to generate other types of prompt sentences and explanatory text. For example, the server may generate a prompt sentence such as:
“Explain in one sentence what factual information needs to be verified in the following claim: ‘The number of new COVID-19 cases in Tokyo exceeded 1000 yesterday.’”
and use the resulting text as an explanation for the user regarding what is being verified. In addition, the server may generate prompt sentences that describe candidate information elements and requested outputs in a structured form. The use of explicit prompt sentences enables the server to steer the generative AI model toward specific computational tasks, such as extracting entities, generating queries, or constructing summaries, rather than performing generic text generation.

The server interacts with an external information search platform through a network interface. The server transmits search character strings generated by the generative AI model to the external platform via structured network requests and receives structured responses that include search results. Each search result may contain a title, a snippet, a link, and metadata such as a publication date or a content type. The server then parses the response and instantiates data records in its internal storage, each record being associated with a specific candidate information item through an identification key.

The server ranks related information records according to similarity measures defined between the extracted candidate information and the content of the search results. In one embodiment, the server applies a similarity scoring algorithm based on cosine similarity between embedding vectors of the candidate sentence and embedding vectors of the search result snippets, where both types of embeddings are produced by the BERT-type contextual model. The server may also incorporate additional features such as domain type (for example, whether the source uses a particular top-level domain), publication recency derived from metadata, and term overlap counts. By combining these features in a ranking function, the server prioritizes related information with higher expected usefulness for fact verification. The server aggregates related information records for each candidate information item into a structured display data object. This display data object includes the original candidate sentence, a normalized representation of the corresponding fact tuple, the search character string used, the ranked list of related information records, and optionally a user-oriented explanation sentence generated by the generative AI model. The server serializes the display data into a format suitable for transmission to the terminal and sends the display data back through the communication network.

The terminal receives the display data and renders it for the user. The terminal highlights segments of the original character information that correspond to candidate information requiring fact checking and displays, for each highlighted segment, the corresponding list of related information items. The terminal may show, for each related information item, a title, a snippet of text, and a link that can be opened in a web browser view. The terminal also displays simple controls that allow the user to input evaluation results, such as buttons labeled “Correct,” “Incorrect,” or “Uncertain,” with respect to each candidate information item.

The user views the displayed candidate information and related information on the terminal. The user may select specific related information items to open source documents in detail, such as official reports or trusted articles. After reviewing these materials, the user provides an evaluation result for each candidate information item by interacting with the terminal's controls. The terminal transmits these evaluation results, including identifiers that link them to specific candidate information items and related information items, back to the server. The server receives user evaluation results and stores these results in association with identification information for candidate information items and related information items. The server uses these stored records as learning data. In one embodiment, the server periodically re-trains or fine-tunes the classifier used to identify candidate information, using supervised learning where candidate sentences confirmed as correct or incorrect provide labeled examples. The server may also adjust parameters of the ranking function for related information by using user evaluations as feedback signals, thereby altering weights assigned to similarity features, recency, or domain trustfulness. The server may further provide this learning data to the generative AI model via a fine-tuning process where additional training steps are applied to update model parameters to better capture the characteristics of factual claims and useful search queries.

The server employs specific learning mechanisms in connection with the contextual model and classifier. For example, the server can use stochastic gradient descent or a variant such as the Adam optimizer to update model weights during training. The server may define a loss function such as cross-entropy loss between predicted class probabilities and ground-truth labels indicating whether sentences are factual or non-factual. For ranking, the server may use pairwise or listwise ranking loss functions where pairs or lists of related information records are labeled based on user evaluations. The server may also apply data augmentation techniques such as paraphrasing, synonym replacement, or time normalization to expand the training dataset beyond the original user inputs.

By employing transformer-based contextual embeddings, explicit prompt-driven use of a generative AI model, and feedback-based model updating, the server improves computer functionality in several concrete ways. The server reduces the number of network interactions with external search platforms by generating higher-quality search character strings, achieving more relevant results with fewer queries. The server also reduces the amount of data that must be transferred to and displayed on the terminal by ranking and filtering search results before transmission. The use of dense vector representations and neural classifiers enables the server to perform fact candidate extraction and result ranking with higher accuracy and lower false-positive rates compared with simple keyword or rule-based systems, thereby decreasing unnecessary downstream processing. The learning mechanisms based on user evaluations continuously adapt the models to specific domains and typical user behavior, which improves processing speed because fewer manual corrections are required over time. The use of a generative AI model for constructing prompt sentences and search character strings introduces non-conventional processing steps that differ from mere human emulation. The server does not simply mirror how a human operator would manually craft queries; instead, the server uses multi-layer transformer architectures with self-attention mechanisms to encode semantic relations and uses controlled prompt design to systematically steer query generation and summarization. The internal representation of candidate information as embedding vectors, tuples of entities, and learned classification scores constitutes a machine-oriented data structure that would not be naturally created in manual workflows. As a result, the system achieves technical effects such as improved computational efficiency in query generation, improved cacheability of intermediate representations, and the ability to reuse embedding vectors across multiple operations such as classification and ranking.

In another embodiment, the server may locally host the generative AI model rather than accessing a remote service. In this case, the server loads a pre-trained transformer model from local storage into memory and executes the model on a graphics processing unit to accelerate inference. The server controls model parameters such as number of layers, attention heads, and hidden dimension size, and may use quantization or pruning techniques to reduce memory usage and inference latency. The server thereby optimizes resource utilization to handle high volumes of fact-checking requests with reduced response times.

In a further embodiment, the server may incorporate additional rule-based modules that operate in conjunction with neural network components. The server may, for instance, identify specific domain patterns such as statistical reports or numerical claims using regular expressions or handcrafted templates, and use these patterns to adjust classification thresholds or to pre-select sentences for deeper analysis. This hybrid approach leverages fast rule-based filtering for simple cases and uses more computationally intensive neural methods for complex or ambiguous cases, thereby improving overall throughput and reducing average processing time per document.

In yet another embodiment, the terminal may provide advanced visualization functions, such as grouping candidate information items by topic or by time, and highlighting discrepancies between different related information sources. The server can prepare display data that includes difference metrics or conflict indicators that show when multiple related information items disagree on specific numerical values or dates. The terminal can then render these indicators to help the user quickly identify potential inconsistencies.

Across these embodiments, the server, the terminal, and the user cooperate within a technical architecture that is specifically configured to improve machine-based processing of character information for fact-checking purposes. The server performs advanced feature extraction, generative prompt construction, optimized query generation, and feedback-driven learning. The terminal presents structured, pre-processed information in a way that reduces cognitive load and supports efficient human oversight. The user provides evaluations that are converted into machine-readable learning data. Because of this integrated design, the system provides a technical improvement over conventional systems that rely on fixed keyword extraction or static query templates, and it results in measurable improvements in accuracy, processing speed, data management efficiency, and communication efficiency within the computer network.

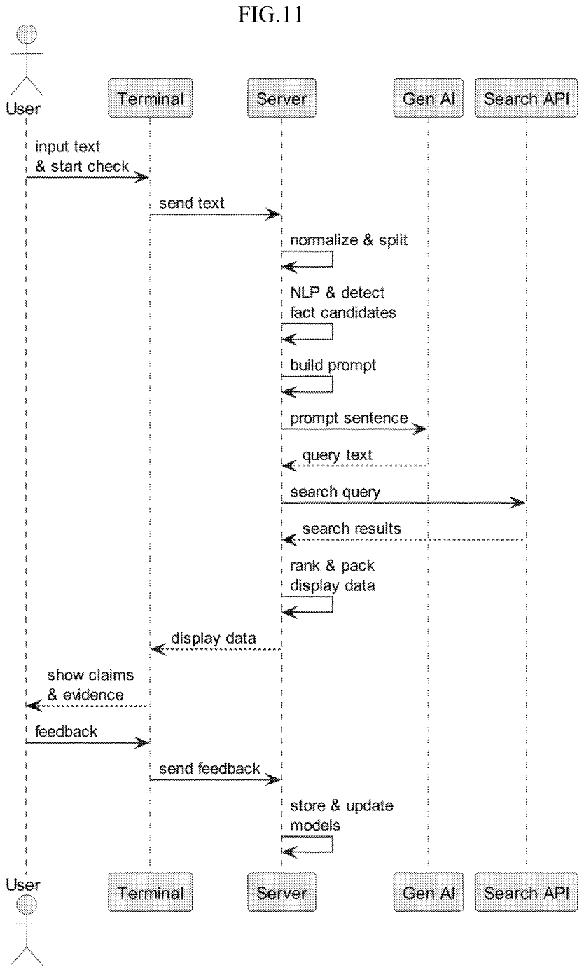

The following describes the processing flow using FIG. 11.

### Step 1:

Server receives character information from the terminal.

Server accepts, as input, a request message containing character information and a session identifier transmitted over a network connection from the terminal. Server validates the request headers and content type, checks the size of the payload, and normalizes the character encoding (for example, to UTF-8). Based on this input, server performs data conversion by standardizing line breaks, removing control characters, and trimming leading and trailing whitespace. Server outputs a normalized text string and stores it together with a generated or received session ID in a storage subsystem.

### Step 2:

Terminal transmits user-entered character information to the server.

Terminal accepts, as input, character information entered or selected by the user through a graphical user interface, such as pasted text or uploaded files. Terminal encodes the character information into a request body, attaches metadata such as language settings and user options, and sends the encoded request to the server via a secure communication protocol. Terminal outputs a network request message that can be processed by the server.

### Step 3:

User provides character information and initiates a fact-checking request.

User inputs, as input, textual content such as news articles, social media posts, or reports into an input area on the terminal display. User reviews the entered content and triggers a fact-checking operation by activating a control element such as a “Start fact-checking” button. User outputs a command signal and associated content selection that cause the terminal to package and send the character information to the server.

### Step 4:

Server segments the normalized text into sentences and tokens.

Server takes, as input, the normalized text string retrieved from storage. Server invokes a natural language processing library of the spaCy type to segment the text into sentences and to tokenize each sentence into words and punctuation tokens. Server performs data processing including sentence boundary detection using statistical models and rule-based patterns, and tokenization using predefined language-specific tokenization rules. Server outputs a list of sentences, where each sentence is represented as an ordered list of tokens with character offsets and part-of-speech tags.

### Step 5:

Server generates contextual embeddings using a transformer-based model.

Server receives, as input, the tokenized sentences from Step 4. Server feeds each token sequence into a contextual language representation model of the BERT type implemented, for example, in a deep-learning framework. Server performs matrix multiplications, multi-head self-attention calculations, and feed-forward transformations across multiple transformer layers to produce a contextual embedding vector for each token and an aggregated embedding for each sentence. Server outputs a sequence of embedding vectors per sentence, which numerically represent semantic and syntactic context.

### Step 6:

Server detects candidate information that may require fact checking.

Server takes, as input, the sentence-level contextual embeddings and the token-level linguistic annotations from the spaCy-type library. Server applies a classifier, such as a neural network or other machine-learning model, to compute a probability score for each sentence indicating whether it likely contains content requiring fact checking. Server calculates these scores by combining embedding vectors with learned weights and applying an activation function. Based on a comparison between each score and a threshold value, server flags certain sentences as candidate information. Server outputs a structured list of candidate information items, each including the sentence text, token indices, and classification score.

### Step 7:

Server extracts structured fact elements from candidate information.

Server receives, as input, the list of candidate information items identified in Step 6. Server uses named-entity recognition results from the spaCy-type library and the contextual embeddings to identify entities such as locations, organizations, persons, quantities, and temporal expressions within each candidate sentence. Server performs data processing by grouping related entities and numerical values into tuples that represent specific factual assertions. For example, server may group a location entity, a subject phrase, a quantity, and a time expression into one tuple. Server outputs a set of structured fact elements for each candidate sentence, including labeled fields such as “location,” “subject,” “quantity,” and “time.”

### Step 8:

Server constructs a prompt sentence for a generative AI model.

Server takes, as input, the structured fact elements and the original candidate sentence text. Server assembles a prompt sentence in natural language that includes instruction content specifying the desired operation of the generative AI model. For example, server creates a prompt sentence such as:
“Given the factual claim: ‘The number of new COVID-19 cases in Tokyo exceeded 1000 yesterday,’ output a concise search query suitable for a web search engine to verify this claim. Only output the query.”

Server performs text concatenation, template filling, and formatting operations to embed the candidate sentence into a standardized instruction pattern. Server outputs the constructed prompt sentence as a text string ready to be sent to the generative AI model.

### Step 9:

Server sends the prompt sentence to the generative AI model and obtains a generated response.

Server accepts, as input, the prompt sentence from Step 8. Server forwards the prompt sentence to a generative AI model via an application programming interface, either to a remote model-hosting service or to a locally hosted model. Server executes an inference operation within the generative AI model, which performs internal computations such as attention-based sequence processing and probability distribution sampling to produce an output text. Server receives, as output, a generated text response from the generative AI model, which typically represents a search character string or related explanatory text.

### Step 10:

Server sanitizes and finalizes a search character string.

Server takes, as input, the generated text response from the generative AI model. Server performs data processing by removing prohibited characters, trimming leading and trailing whitespace, truncating the string if it exceeds length limits of external search platforms, and optionally removing stopwords or redundant phrases. Server may perform token-level filtering based on a predefined vocabulary or whitelist of allowed terms. Server outputs a finalized search character string that is safe and suitable for submission to an external information search platform.

### Step 11:

Server issues a search request to an external information search platform.

Server receives, as input, the finalized search character string. Server constructs a network request including query parameters such as the search character string, language or region constraints, and access credentials for the external information search platform. Server uses a network communication library to send the request via a communication protocol and waits for a response. Server outputs a raw response message, typically in a structured format such as JSON, received from the external information search platform.

### Step 12:

Server parses and structures related information from search results.

Server takes, as input, the raw response message from the external information search platform. Server parses the structured format to extract fields such as titles, snippets, links, publication dates, and, if available, additional metadata. Server performs data processing by constructing internal records that each represent a related information item, associating each record with the corresponding candidate information item using identifiers. Server outputs a collection of structured related information records for each candidate information item.

### Step 13:

Server ranks related information records according to relevance.

Server receives, as input, the collection of related information records and the structured fact elements from earlier steps. Server computes similarity scores between each related information snippet and the candidate sentence or fact tuple using numerical operations, such as generating embeddings for snippets with the same BERT-type model and calculating cosine similarity. Server may also compute feature values for publication recency, domain type, or keyword overlap. Server then applies a ranking algorithm, such as a weighted scoring function, to order the related information records based on their relevance scores. Server outputs an ordered list of related information records for each candidate information item.

### Step 14:

Server generates structured display data for presentation.

Server takes, as input, the ordered list of related information records and the associated candidate information items and fact elements. Server assembles display data objects that include the original candidate sentence, the structured fact elements, the search character string used, and the ranked related information entries. Server may also incorporate a short explanation sentence generated by the generative AI model using an additional prompt sentence, for example:
“Explain in one sentence what factual information needs to be verified in the following claim: ‘The number of new COVID-19 cases in Tokyo exceeded 1000 yesterday.’”

Based on the generative AI model's output, server adds explanatory text to the display data. Server outputs serialized display data ready to be sent to the terminal.

### Step 15:

Terminal receives and renders display data.

Terminal accepts, as input, the display data transmitted from the server. Terminal parses the serialized data, identifies fields such as candidate sentences, fact elements, and lists of related information items, and maps them to user interface components. Terminal performs rendering operations to highlight candidate sentences within the original character information and to display, for each highlighted sentence, an expandable list of related information entries with titles and snippets. Terminal outputs a visual representation on the display that the user can view and interact with.

### Step 16:

User reviews displayed information and provides evaluation results.

User takes, as input, the visual representation of candidate sentences and related information shown on the terminal. User reads the candidate sentences, opens selected related information items, and compares content between the original text and the external sources. Based on this review, user operates input controls on the terminal, such as buttons or selection fields, to label each candidate information item as “Correct,” “Incorrect,” “Uncertain,” or other predefined categories. User outputs evaluation results through the terminal interface.

### Step 17:

Terminal transmits user evaluation results to the server.

Terminal receives, as input, the user's interaction events representing evaluation selections. Terminal associates each evaluation with corresponding identifiers supplied in the display data, such as candidate information IDs and related information IDs. Terminal packages these evaluations and identifiers into a request message and sends the message to the server through the communication network. Terminal outputs a formatted evaluation data payload for server-side processing.

### Step 18:

Server stores user evaluation results and updates learning data.

Server takes, as input, the evaluation data payload received from the terminal. Server parses the payload to extract evaluation labels, candidate information identifiers, and related information identifiers. Server records the evaluation results in a database table or other storage structure, associating each label with specific candidate information items and search results. Server updates learning datasets by appending new labeled examples for use in retraining or fine-tuning the candidate detection classifier, ranking algorithm, or generative AI model behavior. Server outputs updated model training datasets and, optionally, updated model parameters after subsequent training operations.

### Step 19:

Server optionally uses a generative AI model to propose corrected statements.

Server receives, as input, both the original candidate sentence and verified factual values inferred from highly ranked related information items and user evaluations. Server constructs a prompt sentence to instruct the generative AI model to rewrite the original claim accurately, for example:
“Original claim: ‘The number of new COVID-19 cases in Tokyo exceeded 1000 yesterday.’ Verified number: 980. Rewrite the claim accurately in one sentence.”

Server sends this prompt sentence to the generative AI model and obtains, as output, a corrected sentence suggestion. Server sanitizes and stores the suggested corrected sentence, associating it with the original candidate information item. Server outputs corrected statement data that can be transmitted to the terminal for presentation to the user.

### Step 20:

Terminal displays corrected statement suggestions for user confirmation.

Terminal accepts, as input, the corrected statement data from the server. Terminal updates the user interface to show the original candidate sentence alongside the corrected sentence generated by the generative AI model. Terminal presents controls that allow the user to accept, modify, or reject the suggested correction. Terminal outputs an updated visual representation and, depending on subsequent user actions, transmits additional feedback to the server indicating whether the correction was accepted or edited.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern computing environments, large volumes of textual information are continuously generated and consumed through various networked information media. Conventional computer systems typically present such text to users without machine-assisted, fine-grained analysis of which specific portions of the text may contain factual assertions that warrant verification. As a result, users must manually read entire articles, subjectively identify potentially questionable statements, manually formulate search queries, and independently consult multiple information sources. This manual workflow imposes a high cognitive and operational burden on the user and leads to delays and inconsistencies in fact-checking.

From a computer-technology standpoint, existing systems generally treat fact-checking as a separate, user-initiated search operation that is loosely coupled to the underlying text-processing pipeline. Known search interfaces and content viewers are not structurally integrated with machine learning models that can dynamically identify fact-check-worthy statements and generate search queries that are context-aware. Consequently, the computing resources of servers and terminals are not effectively utilized to automate the selection of candidate factual statements, the generation of corresponding search queries, and the association of search results with the original text at a granular level.

Furthermore, there is a lack of mechanisms by which a processor can coordinate: (i) extraction of candidate information requiring fact-checking from character information using machine learning-based natural language processing, (ii) automatic construction of search query data based on structured attributes of the extracted information, and (iii) generation of structured display data that associates portions of the original text with corresponding search results for presentation on a terminal device. Without such mechanisms, systems cannot provide a seamless, real-time interface that directly links specific textual assertions with corroborating or contradicting external information, thereby limiting the technical effectiveness of the system for assisting the user in evaluating credibility.

Accordingly, there is a need for an improved computer-implemented system that reconfigures the operation of a processor to automatically: acquire character information from an information medium, extract and select fact-check target information using a machine learning model, generate and execute search queries against an external information search service, and produce structured display data that precisely associates fact-check target information with corresponding search results, enabling a terminal device to present integrated fact-checking assistance. Such a system should reduce user intervention, improve the efficiency and accuracy of fact-check-related processing, and enhance the overall functioning of the computer system in handling credibility assessment of textual information.

The specific processing by the specific processing unit 290 of the data processing device 12 in Application Example 1 is realized by the following means.

The present invention provides a server comprising a processor configured to acquire, from a terminal device via a communication line, character information included in an information medium being browsed by a user; to extract, by natural language processing using a machine learning model, candidate information requiring fact-checking from text included in the acquired character information and to generate a prompt sentence for instructing a generative information processing model to perform such extraction processing; to input the generated prompt sentence to the generative information processing model, automatically extract the candidate information requiring fact-checking, and select, from the candidate information, information satisfying a predetermined condition as fact-check target information; to analyze event information, quantitative information, time information, and geographic information included in the fact-check target information, construct search terms, and generate search query data based on the search terms; to execute an information search process for an external information search service using the search query data and acquire search result data; to associate the acquired search result data with the fact-check target information on a per-item basis, convert the associated data into structured data, and generate display data to be transmitted to the terminal device; and to cause, based on the display data, the terminal device to present, in a display area of the terminal device, the fact-check target information and corresponding search result information in association with each other, thereby enabling the user to refer to the search result information and determine credibility of the fact-check target information. This enables an improvement in computer functionality by allowing the server processor to automatically transform unstructured character information into structured, fact-check-oriented data, to coordinate machine learning-based extraction and search-query generation in a unified processing pipeline, and to provide the terminal device with display data that directly links specific textual assertions to relevant external information sources, thereby reducing manual user operations, enhancing processing efficiency, and improving the technical performance of the overall fact-checking system.

The term “system” refers to an arrangement of one or more hardware apparatuses and software components that cooperate to perform information processing, including at least a processor and one or more terminal devices connected via a communication line.

The term “processor” refers to a hardware computation unit, such as a central processing unit or an accelerator, that executes instructions of a program to perform data processing operations including acquisition, analysis, generation, and transmission of data.

The term “terminal device” refers to an information processing apparatus operated by a user, such as a client computing device, a portable information terminal, or a display-equipped communication device, that is capable of communicating with a server and presenting information to the user.

The term “communication line” refers to a wired or wireless communication infrastructure, including networks such as the Internet or local area networks, that enables data transmission between the processor and the terminal device or between the processor and external services. The term “information medium” refers to a digital content platform or service on which textual information is published or displayed, including but not limited to websites, online news services, social networking services, and electronic documents.

The term “character information” refers to information expressed as a sequence of characters or symbols representing text, including words, sentences, and paragraphs contained in an article or other textual content of an information medium.

The term “machine learning model” refers to a computational model trained on data to learn patterns and perform tasks such as classification, extraction, or prediction, and includes models based on statistical learning, neural networks, or other learning algorithms.

The term “natural language processing” refers to a set of computational techniques for analyzing, understanding, and generating human language text, including operations such as tokenization, syntactic and semantic analysis, and contextual interpretation.

The term “candidate information requiring fact-checking” refers to portions of text, such as sentences or phrases, that are automatically detected by the processor as containing factual assertions that may need verification against external information sources.

The term “prompt sentence” refers to a text-form instruction generated by the processor that describes a processing task, an extraction condition, or a target range, and is provided as input to a generative information processing model to control or guide its operation.

The term “generative information processing model” refers to a type of machine learning model configured to generate output information, such as extracted text, reformulated text, or structured data, in response to input instructions including prompt sentences.

The term “fact-check target information” refers to information selected by the processor, from the candidate information requiring fact-checking, as satisfying predetermined conditions for verification and being subject to subsequent search and evaluation processing. The term “event information” refers to data describing an occurrence or happening, such as an action, incident, or situation, that is expressed in the text and may form part of the fact-check target information.

The term “quantitative information” refers to numerical data or amount-related expressions, including counts, measurements, percentages, or statistical values, contained in the text and associated with factual assertions.

The term “time information” refers to data indicating temporal aspects of an event, such as dates, times, periods, or relative temporal expressions, that can be used to specify when an event occurred.

The term “geographic information” refers to data representing a place or location, such as a country, region, city, or area, that identifies where an event or situation is said to occur.

The term “search terms” refers to one or more words, phrases, or symbolic expressions constructed by the processor from fact-check target information and used as input criteria for an information search process.

The term “search query data” refers to data generated by the processor that encodes search terms, parameters, and related metadata in a form suitable for submission to an information search engine or service.

The term “information search process” refers to a sequence of operations in which the processor transmits search query data to an information search engine or service and receives corresponding result data relevant to the query.

The term “external information search service” refers to a network-accessible search system, such as a web search service or database search service, that is operated outside the system and provides search result data in response to search queries.

The term “search result data” refers to information returned from an external information search service, including data elements such as titles, summaries, identifiers, network addresses, timestamps, and other attributes of retrieved resources.

The term “structured data” refers to data organized according to a predefined schema or format, such as a record, list, or tree structure, enabling systematic association between fact-check target information and search result data.

The term “display data” refers to data generated by the processor that describes content and layout information for presentation on the terminal device, including associations between text portions and corresponding search results.

The term “display area” refers to a region of a screen or user interface of the terminal device in which text, graphics, and other visual elements are presented to the user.

The term “search result information” refers to part or all of the search result data that is selected, formatted, and presented by the system to the user in association with fact-check target information.

The term “evaluation index relating to factuality” refers to a metric or score calculated by the processor for a unit sentence or word sequence, representing a degree to which the unit is likely to contain a factual assertion that should be considered for fact-checking.

The term “extraction conditions” refers to one or more criteria, thresholds, or rules used by the processor or by a model to determine whether text portions should be designated as candidate information requiring fact-checking.

The term “target range” refers to a scope of text, such as a subset of sentences, paragraphs, or sections, that is designated by the processor or by a prompt sentence as the subject of extraction or analysis.

The term “position information of character strings” refers to data indicating locations of character sequences within the original character information, such as indices, offsets, or range information that can be used to identify corresponding text regions on a display.

The term “summary information” refers to condensed content derived from search result data, such as abstracted text, snippets, or brief descriptions, that represent the essence of retrieved resources.

The term “relevance index” refers to a metric or value indicating a degree of relatedness between search result information and corresponding fact-check target information, used for ordering or selection of displayed results.

The term “text region” refers to a continuous portion of displayed text on a screen that corresponds to a particular subset of character information, such as a sentence, phrase, or paragraph.

The term “hierarchical format” refers to a display arrangement in which information elements are shown in a nested or tree-like structure, with parent-child relationships or levels of detail.

The term “list format” refers to a display arrangement in which information elements are presented as sequential items, such as rows or entries, typically aligned in one dimension for easy scanning by the user.

In one embodiment, a server cooperates with at least one terminal and at least one user to implement the invention. The server operates on a hardware platform such as a rack-mounted computer including a multi-core central processing unit, a graphics processing unit, main memory, non-volatile storage, and a network interface. The server executes an operating system such as a general-purpose server operating system and runs application software including a web server framework, a machine learning runtime library, and network client libraries. The terminal operates on a client computing device such as a smartphone, tablet, or personal computer including a display, an input interface, a processor, memory, and a network communication unit. The terminal executes a client application or web browser capable of obtaining textual content displayed from an information medium and communicating with the server.

The server stores, in a non-transitory computer-readable storage medium, program instructions that cause the server to function as an acquisition module, an analysis module, a generative control module, a query-construction module, a search module, a result-structuring module, and a display-data generation module. The server uses these modules to control concrete data structures in main memory, including text buffers, token sequences, embedding tensors, candidate lists, fact-check target lists, query objects, and structured-result records. The terminal acquires character information from an information medium. The terminal loads, for example, a news article or blog page in a client application or browser, and uses platform-dependent interfaces such as document object model access, webview script injection, or accessibility APIs to read visible text nodes. The terminal concatenates paragraph elements, title elements, and other content-region elements into a single character sequence, normalizes encoding into a uniform text encoding, and stores the sequence in a buffer. The terminal further associates the character sequence with metadata such as a source identifier, timestamp, and language code. The terminal transmits this data to the server using a network protocol such as HTTPS and a client library such as a high-level HTTP client. The server receives the character information from the terminal and stores it in a request-specific data structure. The server assigns a unique internal identifier to each request and allocates memory to hold the input text, including an array of characters and indexes for sentence boundaries. The server may additionally store a mapping from character offsets to paragraph or sentence identifiers to later support highlighting on the terminal.

The server analyzes the character information using a machine learning model for natural language processing. In one embodiment, the server loads into GPU memory a transformer-based language model, such as a bidirectional encoder model with multiple attention layers, trained to produce contextual embeddings for tokens. The server uses a tokenizer, for example a subword tokenizer, to convert the character sequence into a sequence of token identifiers, attention masks, and segment identifiers. The server passes these sequences to the transformer encoder to compute, for each token, a high-dimensional embedding vector. The server then applies, on top of the embeddings, a classification head implemented as one or more fully connected layers with non-linear activation functions to produce, for each sentence or token span, a score indicating a degree of factuality and a likelihood that the span contains a fact-check-worthy assertion.

The server defines candidate information requiring fact-checking as text spans whose scores exceed a first threshold while satisfying additional constraints, such as including at least one named entity and at least one quantitative or temporal expression. The server may use an auxiliary named-entity recognition model or a sequence tagging layer operating on the same embeddings to recognize entities such as persons, organizations, locations, and events. The server associates each candidate span with extracted features including entity types, numerical values, date or time expressions, and geographic descriptors. The server stores each candidate in a candidate list data structure as an object containing at least the original text substring, start and end character offsets, feature fields, and score values.

The server generates a prompt sentence for a generative AI model based on the candidate analysis. The server constructs the prompt sentence as a natural language instruction that specifies extraction tasks, filtering conditions, and desired output formats. For example, the server may generate a prompt sentence such as: “Analyze the following article text and list only those statements that make concrete factual claims involving numbers, dates, or locations, and provide each claim as a separate line.” The server may also embed summary information about the article context and the current candidate list, and may specify language or domain constraints. By encoding structured extraction conditions in a textual prompt, the server can guide a generative AI model to refine or validate the candidate list in a way that differs from simple rule-based filters or generic summarization.

The server inputs the prompt sentence and, optionally, the article text or candidate snippets into a generative AI model. In one embodiment, the server uses a transformer-based generative model, such as an auto-regressive language model with multi-layer attention, trained to follow instructions expressed as natural language prompts. The server encodes the prompt and the contextual text as tokens, feeds them into the generative model, and obtains an output sequence that consists of reformulated claims or extracted fact-check target statements. The server then parses the output sequence according to predetermined delimiters or line breaks to obtain a refined set of candidate statements. The server maps these statements back to the original text using approximate matching, similarity scoring, or alignment based on content and feature overlap, and constructs a final list of fact-check target information. This use of the generative AI model, controlled via a prompt sentence that encodes explicit extraction conditions, produces a candidate set that incorporates contextual reasoning and rephrasing beyond conventional keyword or pattern matching.

The server converts the fact-check target information into structured query objects. The server analyzes each selected statement to extract event information, quantitative information, time information, and geographic information using dedicated parsing modules. For example, the server may use dependency parsing or semantic role labeling on the embeddings produced by the transformer encoder to identify predicate-argument structures, event triggers, and argument roles. The server may normalize time expressions into absolute dates using a calendar module and convert quantity expressions into normalized numeric values. The server may map location mentions into standardized geographic identifiers. The server then constructs search terms by concatenating selected entities, normalized time indicators, and key predicates while omitting extraneous words. The server creates search query data structures that include fields such as a main query string, an optional filter for publication date range, a language code, and a priority score.

The server executes an information search process using the search query data. The server functions as a client to an external information search service, such as a web search engine accessible over a network, and forms HTTP requests that include query strings and parameters encoded in a suitable format. The server may adapt query parameters based on the type of fact-check target information, for example narrowing a date range for time-sensitive claims or restricting domains for governmental data claims. The server sends requests in parallel or in an optimized sequence to reduce latency and uses connection pooling and asynchronous I/O to reduce network overhead and resource usage on the server. The server receives search result data in a structured format, such as a JSON representation containing resource titles, snippets, URLs, and metadata including publication timestamps and source identifiers.

The server structures the search result data and associates it with corresponding fact-check target information. The server creates, for each fact-check target statement, a result record consisting of the statement identifier, the original text, and a collection of search results. The server may compute a relevance index for each result using a scoring function that considers keyword overlap, semantic similarity based on vector representations, source reliability scores, and freshness based on timestamps. The server orders results within each record according to this index. The server converts all such records into a structured data format suitable for transmission, such as a nested object or list structure, including fields for statement text, character position information, summary snippets, URLs, and relevance indices. The server thereby performs a technical transformation from unstructured article text into structured, query-linked data that can be efficiently rendered and interacted with on the terminal.

The terminal receives the display data from the server and maps fact-check target information back to the original displayed article. The terminal uses the character position information to identify the corresponding text regions in the local representation of the article, for example by mapping character offsets to DOM nodes or layout coordinates. The terminal highlights those regions with visual indicators such as background color or underline and attaches user interface elements, such as icons or expandable panels, that give access to associated search result information. The terminal may render search results in a hierarchical format where a top-level entry corresponds to each fact-check target statement and child entries correspond to individual external sources, each displaying a title, a summary snippet, and a relevance indicator. The terminal may alternatively provide a list format where statements and their associated results are presented in a scrollable pane. The terminal thereby enables the user to visually correlate specific text segments with external corroborating information in an integrated display.

The user views the highlighted statements and associated external information on the terminal display. The user may select a statement to expand or collapse its associated search results or activate a link to open a full resource in a browser or in-app viewer. The user is thus able to make an informed judgment regarding the credibility of each fact-check target statement based on the presented external information, without manually performing multiple searches. Although the ultimate judgment is made by the user, the technical operations of the server and terminal substantially reduce the user's cognitive and manual burden by performing precise text-to-result associations at a level of granularity that conventional systems do not provide.

The server achieves technical improvements in computing performance and resource usage by using the described architecture. The server performs the initial candidate extraction with a discriminative transformer encoder that yields dense contextual embeddings and per-span scores, which allows early discarding of low-interest segments and reduction of the number of queries sent to the external search service. This step decreases network traffic and latency by limiting search operations to relevant claims. The server refines these candidates using a generative AI model controlled with a task-specific prompt sentence, which provides a second filtering and reformulation stage and results in better alignment between query content and true factual claims. This combination improves search precision, thereby reducing the number of non-relevant results transmitted and displayed, and consequently reducing communication load and rendering overhead.

The server internally manages data in compact tensor and index forms rather than plain text at all stages, which allows efficient batch processing of multiple statements and reuse of computed embeddings for several tasks, including entity recognition and event parsing. The server may precompute and cache embeddings at the sentence level so that subsequent fact-checking requests for the same article or overlapping content can be served faster, reducing processor load and improving throughput. The server may also adjust thresholds for candidate selection based on historical feedback data, stored in a database, so that over time the model focuses on claims that historically required verification, thus improving overall system accuracy and reducing unnecessary computation.

The machine learning models used by the server are trained using a supervised learning method. The server, in a training environment, receives annotated corpora where sentences or spans are labeled as fact-check-worthy or not. The server initializes model parameters and iteratively updates the parameters using a gradient-based optimization algorithm such as stochastic gradient descent or an adaptive variant, minimizing a loss function such as cross-entropy between predicted labels and true labels. The server may perform data augmentation by paraphrasing labeled sentences, injecting numeric perturbations, or altering temporal expressions to improve model robustness. During training of the generative AI model or during instruction tuning for the generative model, the server uses prompt-response pairs where prompts specify extraction tasks and outputs present lists of claims, and minimizes a language modeling loss on the correct outputs. By explicitly encoding extraction conditions into prompt sentences, the server learns internal parameter configurations that allow context-aware extraction and efficient use of token budgets, which further contributes to computational efficiency in deployment.

The server implements in software a modular architecture separating acquisition, analysis, generative control, query generation, and result structuring modules. This modularization enables independent scaling and optimization of each component. For example, the server can deploy the transformer encoder and the generative model on different hardware accelerators, allowing parallel processing of different requests. The server may implement a rule-based post-filter operating on the outputs of the generative model to enforce system-specific constraints, such as limiting queries to specific domains for certain topics or enforcing minimum-length requirements on search terms. These non-conventional combinations of machine-learned extraction and explicit rule-based post-processing further reduce erroneous queries and improve overall system reliability.

The described system yields technical effects that extend beyond automating a mental process. The server not only replaces manual reading and searching but also restructures internal data representations and processing flows to exploit high-dimensional embeddings and model-driven filters, thereby reducing network load and memory usage compared to naive search approaches where entire articles are repeatedly submitted to search engines as generic queries. The terminal benefits from reduced bandwidth and more compact structured display data, enabling faster rendering and improved user interface responsiveness, particularly on resource-constrained devices. The integrated highlighting and association of statements with structured search results also reduces the need for redundant re-rendering and complex DOM scanning, improving the rendering pipeline's efficiency.

Alternative embodiments are possible. The server may use different variants of transformer models, such as models fine-tuned for specific domains, or may use convolutional or recurrent architectures for some tasks. The server may adjust the generative AI model to operate in a few-shot regime by including example inputs and outputs in the prompt sentence. The terminal may be implemented as a dedicated application, an extension, or a web-based client. The external information search service may be replaced or supplemented by local search over a curated database or a private index, and the query-construction logic may adapt to that environment. Despite such variations, the server, terminal, and user maintain the functional relationships described above: the server transforms unstructured character information into structured fact-check-oriented data using a combination of discriminative and generative models guided by explicit prompt sentences, the terminal presents associated fact-check target information and search result information in an integrated manner, and the user uses this presentation to evaluate credibility.

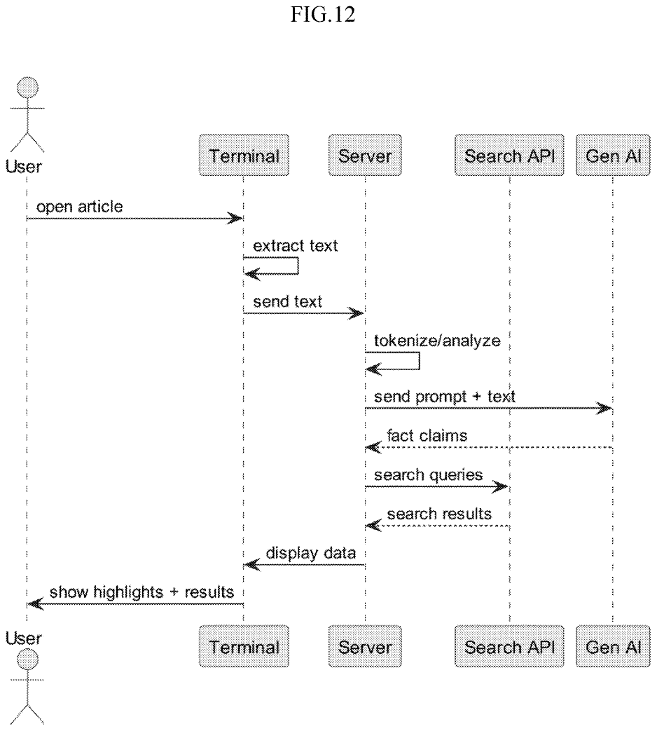

The following describes the processing flow using FIG. 12.

### Step 1:

The terminal acquires article text from an information medium.

The terminal receives, as input, a rendered article page from a content source such as a news site or blog, including markup and visible text. The terminal uses a browser engine, a document object model interface, or an embedded webview to traverse text nodes and extract visible paragraphs, headings, and captions. The terminal filters out navigation elements and scripts, concatenates relevant text nodes into a single character sequence, and normalizes encoding and whitespace. The terminal outputs cleaned character information and associated metadata, such as a source identifier and language code, as a structured data object stored in local memory.

### Step 2:

The terminal transmits the character information to the server.

The terminal receives, as input, the structured character information and metadata generated in Step 1. The terminal uses an HTTP client library to serialize the data into a network message, typically in a structured text format, and attaches communication headers including content-type and authentication information. The terminal establishes an encrypted connection to the server over a communication line and sends the message to a predefined endpoint. The terminal outputs a network request containing the article text and metadata, and then awaits a response from the server while maintaining an internal association between the request and a pending result.

### Step 3:

The server receives and stores the character information.

The server receives, as input, the network request transmitted by the terminal in Step 2. The server uses a network interface and server framework to parse the incoming message, validate headers, and extract the structured character information and metadata. The server allocates memory in a request-specific record, stores the character sequence in a text buffer, and computes sentence boundary indices using delimiters and language-specific rules. The server assigns a unique request identifier and records the mapping between the identifier, the text buffer, and the sentence indices. The server outputs an internal data structure that encapsulates the article text, sentence boundaries, and metadata for downstream processing.

### Step 4:

The server tokenizes the character information and computes contextual representations.

The server receives, as input, the internal data structure created in Step 3 that contains the article text and sentence boundaries. The server loads a tokenizer configured for a transformer-based language model and converts each sentence into a sequence of token identifiers, attention masks, and segment identifiers. The server groups token sequences into batches and feeds them into a transformer encoder model deployed on a computing engine such as a graphics processing unit. The model computes, for each token position, a contextual embedding vector by applying multi-head self-attention and feed-forward operations. The server aggregates token embeddings to form sentence-level representations, such as by pooling or using designated positions. The server outputs token sequences, token-level embeddings, and sentence-level vectors as numerical tensors stored in memory.

### Step 5:

The server detects candidate information requiring fact-checking.

The server receives, as input, the token-level and sentence-level embeddings generated in Step 4 together with the sentence segmentation information. The server applies a classification head, implemented as one or more fully connected layers with non-linear activation, to each sentence-level vector or to pooled span embeddings to compute a score indicating the likelihood that the corresponding sentence or span contains a fact-check-worthy assertion. The server compares these scores with a predefined threshold and selects those sentences or spans whose scores exceed the threshold. The server further analyzes the selected spans using an entity recognition component that inspects embeddings and token labels to detect numeric expressions, temporal expressions, and geographic mentions. The server filters out spans that lack required feature types and retains spans that satisfy feature-based conditions. The server outputs a candidate list consisting of records that include the original text substrings, character offset ranges, and feature annotations for each candidate.

### Step 6:

The server generates a prompt sentence for a generative AI model.

The server receives, as input, the candidate list from Step 5 and the original article text. The server constructs a prompt sentence by concatenating a task description, extraction conditions, and optional examples, followed by either the entire article text or selected candidate snippets. The server explicitly encodes constraints such as “include only statements with concrete numbers and dates” and “output each claim on a separate line.” For example, the server may generate a prompt sentence such as: “Analyze the following article text and list only those statements that make concrete factual claims involving numbers, dates, or locations, and provide each claim as a separate line.” The server performs string assembly operations to construct a continuous prompt sequence and may truncate or segment the article text to satisfy length limits while preserving relevant context. The server outputs a prompt text string and associated context to be used as input for a generative AI model.

### Step 7:

The server refines fact-check target information using the generative AI model.

The server receives, as input, the prompt text string and context generated in Step 6. The server encodes the prompt into token identifiers using a tokenizer specific to the generative AI model and feeds the tokens into a generative transformer model configured for auto-regressive decoding. The model computes hidden representations and, at each decoding step, predicts a probability distribution over possible next tokens based on the prompt and previously generated tokens. The server samples or selects the most probable tokens according to decoding parameters such as temperature and top-k filtering, generating a sequence of output tokens that represent reformulated fact-check target statements. The server converts the tokens back into text, splits the output into individual statements using line breaks or separators, and interprets each line as a candidate fact-check target statement. The server then aligns these generated statements with the original article text by computing similarity scores between generated segments and original sentences using embedding-based distance measures. The server selects alignments that exceed a similarity threshold and updates the fact-check target list to include only matched and validated statements. The server outputs a refined list of fact-check target information, each with associated character positions and feature annotations.

### Step 8:

The server constructs search query data from fact-check target information.

The server receives, as input, the refined fact-check target list from Step 7. For each fact-check target statement, the server parses the text using dependency parsing or semantic role labeling operating on the previously computed embeddings, thereby identifying predicate-argument structures and event triggers. The server extracts event information, quantitative values, time expressions, and geographic entities, and normalizes them; for example, the server converts relative dates into absolute dates using the current system date and converts numeric phrases into standardized numeric representations. The server generates search terms by selecting key predicates and normalized entities while discarding function words and redundant modifiers. The server assembles these terms into a query string and associates additional parameters such as language, time window, and source restrictions. The server creates search query data objects containing the query string, parameters, target statement identifiers, and priority scores. The server outputs a collection of query objects ready for network transmission.

### Step 9:

The server executes external information search requests and retrieves search results.

The server receives, as input, the collection of query objects generated in Step 8. The server initializes or reuses a network client and, for each query object, constructs an HTTP request to an external information search service, embedding the query string and parameters in the request path or body. The server schedules the requests using asynchronous or parallel execution, subject to rate limits and resource constraints, to minimize overall response time. The server sends the requests over the communication line and waits for responses. Upon receiving responses, the server parses each response body to extract elements such as titles, snippets, resource locators, publication dates, and source identifiers. The server creates intermediate result records that map each query to its corresponding set of raw search results. The server outputs a structured representation of raw search result data per query.

### Step 10:

The server ranks and associates search results with fact-check target information.

The server receives, as input, the structured raw search result data from Step 9 and the list of fact-check target statements from Step 7 or Step 8. For each statement, the server retrieves the corresponding query's results and computes relevance scores for each result. The server may compute a relevance score by combining textual similarity between the statement and the result snippet, overlap of numeric and temporal features, domain reliability scores, and recency based on publication dates. The server normalizes these scores and sorts the results in descending order. The server then associates each sorted result set with the identifier and character offsets of the corresponding fact-check target statement. The server constructs structured data records that contain, for each statement, the statement text, character positions, and a ranked list of search results with fields for title, snippet, resource locator, publication time, and relevance index. The server outputs a consolidated structured-result dataset.

### Step 11:

The server generates display data for transmission to the terminal.

The server receives, as input, the consolidated structured-result dataset from Step 10, as well as the original article metadata. The server converts the dataset into a compact data structure optimized for display, such as a nested list or tree of statements and associated search results. The server includes, for each statement, position information in the article text, a truncated version of the statement, and a limited number of top-ranked search results. The server may compress or encode the data to reduce size, for example by removing duplicate fields or using short identifiers. The server serializes this structure into a transferable format and attaches response metadata such as schema version and language. The server outputs a display data payload and transmits it to the terminal over the communication line as a network response.

### Step 12:

The terminal receives the display data and prepares a user interface.

The terminal receives, as input, the display data payload transmitted by the server in Step 11. The terminal deserializes the payload and reconstructs the nested structure of statements and associated search results. The terminal maps the character position information for each statement to internal representations of the displayed article, such as document object model nodes or layout coordinates. The terminal constructs user interface components, including highlight overlays for statement regions and expandable panels or lists for search results. The terminal binds user input events, such as taps or clicks, to these components so that activation of a highlighted region triggers display of associated search results. The terminal outputs an updated user interface state that includes visual markers in the article and prepared containers for presenting fact-check-related information.

### Step 13:

The terminal presents highlighted statements and associated search results to the user.

The terminal receives, as input, the updated user interface state generated in Step 12. The terminal renders the article text on the display, applying highlight styles to text regions corresponding to fact-check target statements. The terminal displays, in a designated area or overlay, a list or hierarchical view of statements and their associated search results, including titles, snippets, and relevance indicators. When the user interacts with a highlighted region or list item, the terminal expands or collapses the corresponding result section and may open external resources in a browser view when requested. The terminal outputs rendered graphical content on the display and interaction events that reflect the user's input.

### Step 14:

The user reviews the presented information and evaluates credibility.

The user receives, as input, the highlighted article content and the associated search results displayed by the terminal in Step 13. The user inspects the statements marked for fact-checking and compares them with the snippets and sources presented by the terminal. The user may navigate between different statements, open detailed external resources, and form a judgment as to whether the original statements are credible or questionable. The user's evaluation, although cognitive, is facilitated by the specific mapping between textual assertions and external evidence that the server and terminal collaborate to produce. The user outputs, in some embodiments, explicit feedback through the terminal, such as marking statements as accurate or inaccurate, which the terminal can capture as interaction data for potential further processing by the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional fact-checking workflows for large volumes of text data rely heavily on manual identification of check-worthy statements, ad hoc formulation of search queries, and unstructured inspection of search results. Even when automatic tools are used, they are often limited to simple keyword extraction or rule-based filters that do not fully exploit context, do not adapt over time, and do not provide structured evidence summaries. As a result, computer systems that support fact-checking tend to exhibit poor scalability, high latency, and inconsistent output quality, particularly when processing long or complex natural language documents.

More specifically, existing systems typically treat the detection of factual claims, the generation of search queries, and the interpretation of search results as loosely coupled tasks. Such systems do not effectively integrate a statistical learning model with a generative AI model under explicit prompt control, and therefore cannot consistently transform unstructured text into structured factual representations that are optimized for downstream retrieval and evaluation. In addition, conventional systems generally do not use historical interaction data to refine prompt generation rules or query generation rules, and thus cannot improve their own behavior as they are used.

Furthermore, many systems simply return raw search results without ranking them according to their evidentiary value or presenting them in a format that allows efficient comparison and verification by a user. These systems often lack an interactive verification loop in which a user can dynamically adjust search conditions or prompt content and cause the system to re-run the retrieval and summarization steps in a coordinated manner. This absence of an integrated, learning-based control mechanism over the entire pipeline leads to suboptimal utilization of computational resources and inconsistent factuality judgments.

Accordingly, there is a need for an improved computer-implemented system that (i) automatically identifies statements requiring factual verification from natural language text by combining a natural language processing algorithm and a statistical learning model, (ii) uses a generative AI model under explicitly constructed prompt sentences to structure such statements and generate effective search term sequences, (iii) ranks and filters retrieved information based on similarity and reliability metrics, (iv) generates evidence-based summaries and provisional truth classifications via prompt-controlled interaction with the generative AI model, and (v) continuously adjusts prompt generation rules and search term generation rules based on accumulated history information and interactive user feedback. Such a system would constitute an improvement in computer technology by providing a more efficient, adaptive, and accurate fact-checking pipeline implemented by a processor.

The specific processing by the specific processing unit 290 of the data processing device 12 in Example 2 is realized by the following means.

The present invention provides a server comprising a processor and a memory, the processor being configured to receive character information distributed through an information delivery service, mechanically extract candidate text segments representing descriptions requiring verification of factuality by using a natural language processing algorithm and a statistical learning model, generate prompt sentences including instruction content for a generative AI model so as to confirm the candidate text segments as structured factual information, input the prompt sentences into the generative AI model to obtain structured data including attribute information, generate search term sequences based on elements included in the structured data and transmit search requests including the search term sequences to an information retrieval function, perform ranking and elimination processing on related information obtained from the information retrieval function by using a similarity calculation algorithm and a reliability evaluation rule to generate organized search result data, generate further prompt sentences including instruction content for the generative AI model so as to generate explanatory texts indicating evidential relationships and provisional truth classifications based on the organized search result data and the structured data, input the further prompt sentences into the generative AI model to obtain summary information and determination information, store, in the memory as history information, the extracted factual information and the related information, update generation rules for the prompt sentences or the search term sequences based on the history information through a learning process, and present the summary information, the determination information, and the organized search result data to a user in a format that supports interactive selection and modification of search conditions or prompt content, thereby enabling re-execution of the retrieval and summarization steps. This enables a computer-implemented fact-checking pipeline in which the detection, retrieval, and evaluation of factual statements are tightly integrated and adaptively optimized at the processor level, improving processing efficiency, consistency, and accuracy compared to conventional systems that perform these operations in a fragmented or non-learning manner.

The term “system” refers to a combination of hardware and software components including at least one processor, a memory, and one or more peripheral devices configured to execute the processes described in the claims as an integrated whole.

The term “processor” refers to one or more hardware processing units, such as a central processing unit or a graphics processing unit, configured to execute instructions stored in a memory to perform arithmetic, logical, and control operations for implementing the claimed functions.

The term “memory” refers to one or more non-transitory storage media, such as semiconductor memory devices or magnetic storage devices, configured to store programs, parameters, intermediate data, history information, and other information used by the processor.

The term “display device” refers to an output apparatus, such as a flat-panel display or a monitor, configured to visually present information to a user under control of the processor.

The term “input device” refers to an input apparatus, such as a keyboard, pointing device, touch panel, or other user interface device, configured to receive operation inputs, text inputs, and instructions from a user.

The term “information delivery service” refers to an information provision environment, such as an electronic communication service or online distribution platform, through which character information is distributed, published, or made available.

The term “character information” refers to information expressed in a text format, including but not limited to sentences, phrases, or documents composed of characters in one or more natural languages.

The term “candidate text segments” refers to portions of the character information, such as clauses, sentences, or spans of text, that are identified by the processor as potential descriptions requiring verification of factuality.

The term “description requiring verification of factuality” refers to a textual statement that asserts a condition, event, quantity, or relationship which can be evaluated as true, false, or uncertain based on external evidence.

The term “natural language processing algorithm” refers to a computational procedure, implemented in software and executed by the processor, that analyzes natural language text, including processes such as tokenization, syntactic analysis, semantic analysis, or contextual analysis.

The term “statistical learning model” refers to a machine-learned model, such as a classifier or sequence tagger, that is trained on data to infer patterns or labels and that is used by the processor to detect or classify descriptions requiring verification of factuality.

The term “generative AI model” refers to a machine-learned generative model, such as a large language model, configured to output natural language text or structured data in response to input data and instructions provided in a prompt sentence.

The term “prompt sentence” refers to a text-based instruction sequence provided as input to the generative AI model, the instruction sequence including at least one description of a task and optionally additional context data or constraints.

The term “structured factual information” refers to factual content represented in a structured form, such as a record or object with predefined fields, that explicitly describes elements such as an event, an entity, a time, and a quantity.

The term “structured data including attribute information” refers to data organized into a predetermined format, such as a table or schema, in which each record has one or more attributes indicating properties such as target event, location, time point, or numerical value.

The term “target event” refers to an occurrence or situation described in the character information that is the subject of factual verification.

The term “place” refers to a geographic location, such as a region, area, or administrative unit, associated with a target event described in the character information.

The term “time point” refers to a temporal specification, such as a date or time, at which a target event is asserted to occur in the character information.

The term “quantity” refers to a numerical value or measure, such as a count, amount, or magnitude, included in a description requiring verification of factuality.

The term “search term sequence” refers to an ordered set of one or more words, phrases, or tokens generated by the processor for submission as a query to an information retrieval function.

The term “search request” refers to an electronic request message, including at least a search term sequence, that is transmitted by the processor to an information retrieval function in order to obtain related information.

The term “information retrieval function” refers to a retrieval mechanism, such as a search engine or database query engine, configured to receive a search request and return related information based on the search term sequence.

The term “related information” refers to data items, such as documents, snippets, titles, or links, returned by the information retrieval function in response to a search request and considered by the processor as potentially relevant to a description requiring verification of factuality.

The term “similarity calculation algorithm” refers to a computational method, executed by the processor, that calculates a similarity measure between two or more pieces of text or data, such as between a claim and a retrieved snippet.

The term “reliability evaluation rule” refers to one or more criteria or heuristics, encoded as program logic or parameters, used by the processor to evaluate the reliability or trustworthiness of related information or its source.

The term “ranking processing” refers to a process executed by the processor in which related information is ordered based on one or more scores, including similarity scores and reliability scores.

The term “unnecessary information elimination processing” refers to a process executed by the processor in which related information that does not satisfy predetermined conditions, such as a threshold similarity or reliability, is removed or filtered out.

The term “search result data” refers to organized data representing the outcome of an information retrieval process, including at least identifiers, textual snippets, and associated metadata for related information.

The term “verification target of factuality” refers to an individual instance of a factual description, derived from the character information, for which the system performs verification using related information.

The term “summarization target information” refers to a combination of structured data and search result data that serves as input to a generative AI model for generating explanatory text, summary information, or determination information.

The term “explanatory text” refers to natural language text generated to explain evidential relationships between a verification target of factuality and related information, including reasons for a provisional truth classification.

The term “provisional truth classification” refers to a tentative categorization of a verification target of factuality, such as supported, contradicted, or uncertain, based on the available related information.

The term “summary information” refers to condensed textual or structured output generated by the generative AI model that captures essential aspects of the evidential situation regarding a verification target of factuality.

The term “determination information” refers to data including at least a provisional truth classification and optionally associated reasons, scores, or indicators, describing the outcome of an automated evaluation of factuality.

The term “history information” refers to stored records of past processing, including extracted factual information, related information, prompt sentences, search term sequences, and associated results used for subsequent learning or adjustment of rules.

The term “learning process” refers to a computational procedure by which the processor updates parameters, rules, or models for generating prompt sentences or search term sequences based on history information.

The term “generation rule for the prompt sentence” refers to a set of conditions, templates, or algorithms used by the processor to construct prompt sentences supplied to the generative AI model.

The term “generation rule for the search term sequence” refers to a set of conditions, templates, or algorithms used by the processor to construct search term sequences for submission to the information retrieval function.

The term “user operation screen” refers to a graphical user interface displayed on the display device, through which a user can view information and provide inputs such as selections or commands.

The term “interactive verification process” refers to a process in which the system responds to user inputs, including selection of verification targets and modification of search conditions or prompt content, by re-executing retrieval and summarization steps and updating displayed results.

In one embodiment, a server, a terminal, and a user cooperate to implement a fact-checking support system. The server includes at least one processor, a main memory, a non-transitory storage device, a network interface, and is connected via a communication network to one or more terminals. The terminal includes a processor, a display device, and an input device, and executes a client application such as a web browser or a native application. The user operates the terminal to input text data, review fact-checking results, and provide interactive feedback.

The server executes an application program implemented, for example, using a runtime environment such as Python with a web framework or another server-side framework, and a machine learning stack including a numerical computation library and a neural network library. The server further executes a natural language processing library, a tokenizer component, and a client library for accessing an external generative AI model via an application programming interface.

The server uses a general-purpose processor such as a multi-core central processing unit and, in some embodiments, an accelerator such as a graphics processing unit. The server loads into memory a trained statistical learning model for claim extraction, for example a transformer-based encoder model similar to a bidirectional encoder representation model, implemented using a deep learning framework. The server also accesses an external generative AI model, for example a large language model hosted on a remote inference service, by transmitting a prompt sentence and receiving a generated response over the network.

The server stores incoming text data, intermediate representations, and output data in a relational data store such as a row-oriented database, or an in-memory key-value store. The server maintains data structures including: (i) a request record containing a request identifier, user identifier, and raw character information; (ii) a list of candidate text segments with associated confidence scores; (iii) a structured claim table with fields for event, place, time point, and quantity; (iv) a search query table storing search term sequences; (v) a search result table linking claims to ranked related information; and (vi) a history table storing past interactions, prompts, and system outputs.

The server applies a natural language processing algorithm and a statistical learning model to process character information. The server uses a tokenizer to convert input text into a sequence of tokens with associated token identifiers. The server feeds the token identifiers into the transformer-based encoder. The encoder comprises multiple layers of self-attention and feed-forward sublayers, each with parameters including attention weight matrices, projection matrices, and bias vectors. The server obtains hidden representations for each token and passes them through a classification head that outputs probability distributions over label types, such as “part of factual claim” or “not part of claim.” The server computes a confidence score for each token span and selects continuous spans whose aggregated score exceeds a predetermined threshold as candidate text segments.

The server thereby performs data processing inside the statistical learning model that is not a simple rule-based filter. The model uses context-aware self-attention mechanisms to weigh each token relative to all other tokens in the text, enabling the server to distinguish between narrative content and factual assertions in long, complex documents. This improves technical performance by reducing false positives and false negatives in candidate selection compared to conventional keyword-based extraction, resulting in more efficient downstream query generation and retrieval.

The server then uses a generative AI model under explicit control of a prompt sentence. The server constructs a prompt sentence in natural language that contains both instructions and data. In one embodiment, the server generates a prompt sentence such as:
“You are an assistant that identifies factual claims for fact-checking. From the following text and preliminary extracted spans, produce a list of factual claims. For each claim, specify: (1) the full claim text, (2) the location, (3) the date or time, and (4) any numerical quantities. Text: [original text]. Preliminary spans: [candidate spans]. Return the claims in a clear, human-readable format.”

The server transmits this prompt sentence to the generative AI model via an application programming interface. The generative AI model comprises a multi-layer transformer decoder with a large number of parameters, trained via supervised and unsupervised learning on large text corpora. The generative AI model internally performs attention over the tokens in the prompt sentence and generates output tokens one by one. The server receives the generated text and parses it according to patterns defined in a prompt design rule set, such that structured factual information is extracted as structured data including attribute information.

The server uses predetermined patterns and lexical cues in the generated text to map segments to structured fields, such as detecting phrases like “Location:” or “Date:” and mapping the following text into a location field or a time field. The server thus converts the free-form output of the generative AI model into a fixed data schema. This combination of a statistical learning model and a generative AI model under explicit prompt control enables the server to transform unstructured text into structured factual representations in a manner that is not simply a human-like reading, but an algorithmic transformation that supports efficient subsequent computation.

The server then generates search term sequences. The server extracts key tokens from each structured claim, including names of locations, nouns referring to events, lexical items indicating quantities, and time expressions. The server applies a weighting algorithm to these tokens, where tokens associated with the event and quantity fields are given higher weights. The server removes stop words and low-information tokens using a stop-word list and part-of-speech tags generated by a natural language processing library. The server optionally calls the generative AI model again with a prompt sentence such as:

“Rewrite the following factual claim as an effective search query to verify the claim. Keep the query short and include only the most important keywords. Claim: [claim text].” The server then receives a refined search phrase from the generative AI model and combines it with the machine-extracted key tokens to form the final search term sequence. The server thereby generates a search term sequence that is tailored to retrieval quality, rather than simply using the original claim text verbatim. This improves both recall and precision of retrieved related information, which in turn reduces the number of irrelevant documents processed and enhances computational efficiency.

The server sends the search term sequence to an information retrieval function, for example an external search service. The server transmits a search request including the search term sequence and optional parameters such as language, region, and result count. The information retrieval function returns related information in the form of a result set including titles, snippets, resource locators, and metadata. The server stores these records in a search result table linked to the corresponding claim.

The server performs ranking and elimination processing on the related information. The server encodes both the claim text and each snippet into vector representations using an embedding model, such as a sentence embedding model implemented in a neural network library. The embedding model may be a transformer encoder fine-tuned on similarity tasks. The server computes cosine similarity between the claim vector and each snippet vector and obtains similarity scores. The server also computes a reliability score for each result using a reliability evaluation rule, which may assign different base scores to domain types, penalize domains on a blocklist, and factor in recency of publication based on timestamps.

The server combines the similarity score and reliability score into a composite relevance score using a weighted sum or a logistic function. The server then sorts the related information by the composite relevance score and removes documents whose score is below a dynamic threshold. The server stores the resulting ranked list as search result data, organized by verification target of factuality.

By using vector-based similarity and reliability evaluation rules at the server, the system reduces the need for the user to manually scan large, unranked result sets. This yields a technical improvement in data management and processing by reducing input/output operations and decreasing average latency for presenting useful evidence. Additionally, by discarding low-score items early, the server reduces memory usage and network load when transmitting results to the terminal.

The server subsequently performs evidence summarization and provisional truth classification. The server constructs a further prompt sentence that incorporates the structured claim and a subset of high-ranking snippets. In one embodiment, the server generates a prompt sentence such as:
“You are a fact-checking assistant. Given the claim and the web search snippets below, (1) decide whether the evidence mostly supports, mostly contradicts, or is insufficient for the claim, and (2) provide a short explanation. Claim: [claim text]. Snippets: [title and snippet list]. Answer concisely in English, indicating one of: ‘supported’, ‘contradicted’, or ‘uncertain’, followed by a brief explanation.”

The server passes this prompt sentence to the generative AI model. The generative AI model processes the concatenated text and generates an output sequence. The server parses the output into summary information and determination information. The server uses pattern-based extraction and, optionally, a small classifier to map textual labels such as “supported” or “contradicted” into an internal classification code. The server stores the explanation text and classification code in association with the claim.

The server then presents the summary information, determination information, and search result data to the terminal. The server formats the data for transmission, for example as a hierarchical data structure. The terminal receives this data and renders it on the display device using a client-side framework. The terminal displays, for each verification target of factuality, the claim text, a short label such as “likely supported,” the explanatory summary, and a list of links or snippets. The user views these outputs on the display device and can quickly assess which claims are well-supported and which require further scrutiny.

The terminal receives user interactions. The user uses the input device to select a particular claim, adjust filters such as time range or domain type, or request a more detailed explanation. The terminal transmits these user instructions to the server. The server interprets the instructions as modifications to search conditions or prompt contents. The server may narrow search term sequences to include additional constraints such as specific domains, or modify the prompt sentence to emphasize certain aspects of the claim. The server then repeats the retrieval and summarization processes based on the modified parameters, allowing an interactive verification loop.

The server records all such interactions as history information. The server stores, for each session, the character information, candidate text segments, structured claims, prompt sentences, search term sequences, search results, summary information, and determination information. The server then applies a learning process to update generation rules for prompt sentences and search term sequences. For example, the server may compute statistics on which prompts lead to lower user overrides or corrections, and adjust templates or parameter weights accordingly. The server may employ supervised learning, where human corrections are treated as labels for desirable outputs, and use optimization methods such as stochastic gradient descent to update weights in a small auxiliary model that controls aspects of prompt construction or query expansion.

By iteratively adjusting the generation rules based on history information, the server improves its ability to produce effective prompts and queries over time. This leads to improved retrieval accuracy and more reliable summaries. The technical effect is that the system self-optimizes as it is used, reducing redundant network calls, lowering average response time, and improving the match between generated prompts and the behavior of the generative AI model. This improvement is not merely an automation of human editing; instead, it uses machine learning on system-internal metrics, which is a non-traditional, computer-centric technique to refine the internal control flow and data structures of the system.

In another embodiment, the server uses different neural network architectures for claim extraction and similarity computation. The server may employ a convolutional neural network for short text classification, or a recurrent neural network for processing sequences, instead of a transformer encoder. The server may also use alternative loss functions such as cross-entropy loss or margin-based ranking loss during training, and perform backpropagation and weight updates using an optimizer such as Adam. The training data may be augmented using techniques such as random word masking or synonym replacement to improve robustness. Although these training operations may be carried out offline, the resulting trained parameters directly affect the inference behavior at runtime, thereby altering how the processor processes text data.

In yet another embodiment, the server may host the generative AI model locally instead of accessing a remote inference service. The server may then allocate a dedicated accelerator device, partition the model across multiple compute nodes, and optimize memory layout and batch size to achieve higher throughput. In such a configuration, the server can further reduce network latency and maintain higher control over prompt-response timing, which improves responsiveness and throughput for large-scale fact-checking workloads.

The system thus provides technical effects including: (i) reduction of computational waste by filtering and structuring text before retrieval; (ii) improvement in retrieval accuracy via vector similarity and reliability-based ranking; (iii) reduction of user cognitive load through evidence summarization and structured presentation; (iv) improvement in processing throughput and latency via history-based adaptation of prompt and query generation; and (v) reduction in network and storage requirements by discarding low-relevance data early in the pipeline. These effects are achieved by specific data structures, machine learning models, and algorithmic control flows implemented by the server, and are not obtained merely by computerizing a preexisting manual process.

Multiple variations may be adopted without departing from the spirit of the invention. The server may support additional languages for character information, use different prompt templates tailored to different domains, or integrate additional scoring features such as temporal consistency checks or cross-source divergence metrics. The terminal may be a portable communication device, a stationary workstation, or another computing device with a display and input capability. The user may be an individual fact-checker, an editorial team, or an automated downstream system that consumes the structured outputs. In all such cases, the server, the terminal, and the user cooperate such that the processor executes the described data processing and data computation, thereby implementing the claimed system in a concrete and technically advantageous manner.

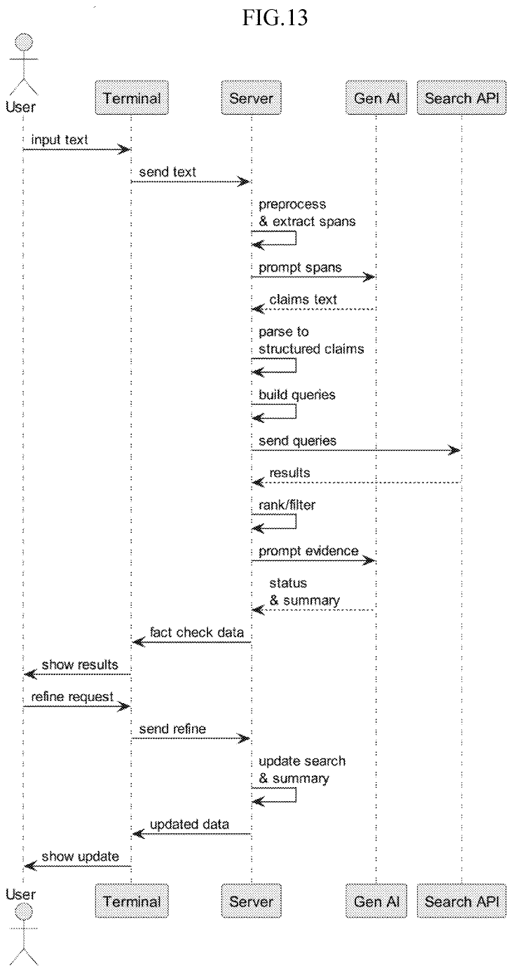

The following describes the processing flow using FIG. 13.

### Step 1:

The user operates the terminal to open a client application and to input character information obtained from an information delivery service.

The terminal receives, as input, raw text such as news articles or social media posts, typed or pasted by the user into an input field.

The terminal converts the input text into a request payload that includes at least the text string and metadata such as language and user identifier, and the terminal sends this payload to the server via a network protocol.

The output of Step 1 is a structured request message containing character information, transmitted from the terminal to the server.

### Step 2:

The server receives the request message from the terminal through a network interface.

The server takes as input the structured request message, parses the message to extract the character information and associated metadata, and stores the data in a temporary data record in a memory or storage device.

The server performs basic preprocessing, including character encoding normalization, removal of control characters, and segmentation of the text into sentences based on punctuation and language-specific rules.

The output of Step 2 is a normalized text representation and a set of sentence objects associated with a request identifier in the server's internal data structures.

### Step 3:

The server loads, from the memory or storage device, parameters of a statistical learning model for claim extraction, such as a transformer-based encoder with a classification head. The server receives, as input, the normalized text representation from Step 2, and applies a tokenizer component to convert sentences into sequences of token identifiers and attention masks.

The server performs data computation by feeding these token identifiers into the statistical learning model running on a processor or an accelerator, thereby obtaining label scores for each token indicating whether it belongs to a factual claim segment.

The server aggregates token-level label scores into span-level confidence scores using a span-building algorithm, and selects contiguous spans whose confidence exceeds a threshold as candidate text segments requiring verification of factuality.

The output of Step 3 is a list of candidate text segments, each with a start position, end position, and confidence score associated with the original text.

### Step 4:

The server prepares a prompt sentence for a generative AI model to refine and structure the candidate text segments.

The server receives, as input, the original character information and the list of candidate text segments from Step 3, and embeds them into a natural language template that includes explicit instructions.

The server generates a prompt sentence such as: “You are an assistant that identifies factual claims for fact-checking. From the following text and preliminary extracted spans, produce a list of factual claims. For each claim, specify: (1) the full claim text, (2) the location, (3) the date or time, and (4) any numerical quantities. Text: [original text]. Preliminary spans: [candidate spans]. Return the claims in a clear, human-readable format.”

The server sends this prompt sentence to a generative AI model via an application programming interface, and the generative AI model returns, as output, generated text containing refined factual claims and their attributes.

The output of Step 4 is a generative-model response text that describes structured factual claims derived from the candidate text segments.

### Step 5:

The server converts the generative-model response text into structured data including attribute information.

The server takes as input the generated text from Step 4 and applies pattern-matching rules and a parsing module to detect markers such as “Claim:”, “Location:”, “Date:”, and “Number:”, and to extract the corresponding values.

The server constructs, for each extracted claim, a structured record containing fields for claim text, event description, place, time point, quantity, and an internal claim identifier, and stores these records in a structured claim data table.

The server optionally eliminates duplicate or overlapping claims by computing similarity between claim texts and discarding near-identical entries.

The output of Step 5 is a set of structured claim records, each representing one verification target of factuality with explicit attributes.

### Step 6:

The server generates search term sequences for each structured claim to be used in information retrieval.

The server receives, as input, the structured claim records from Step 5 and applies a keyword extraction algorithm that selects high-importance tokens based on part-of-speech tags, field types (event, place, time, quantity), and frequency statistics.

The server removes stop words and low-information tokens, weights key tokens such as location names and numerical values more heavily, and arranges them into an ordered search term sequence.

The server optionally constructs a secondary prompt sentence such as: “Rewrite the following factual claim as an effective search query to verify the claim. Keep the query short and include only the most important keywords. Claim: [claim text].” and sends it to the generative AI model to obtain a refined query phrase.

The server merges the machine-extracted keywords and the refined phrase into a final search term sequence for each claim.

The output of Step 6 is a mapping from each claim identifier to a finalized search term sequence optimized for retrieval.

### Step 7:

The server performs information retrieval using an external or internal information retrieval function.

The server takes as input the finalized search term sequence for each claim from Step 6 and constructs a search request including query terms, language constraints, region constraints, and a requested number of results.

The server transmits the search request to a search engine or database query engine and receives, as output, a set of related information items containing titles, snippets, resource locators, and timestamps.

The server stores each retrieved item in a search result data structure, linked to the corresponding claim identifier for later ranking and analysis.

The output of Step 7 is a collection of raw search result entries grouped by claim.

### Step 8:

The server ranks and filters the related information to form organized search result data. The server receives, as input, the raw search result entries and the original claim texts.

The server encodes each claim text and each snippet using an embedding model to obtain vector representations, computes similarity scores (for example, cosine similarity) between claim vectors and snippet vectors, and calculates reliability scores based on domain type, recency, and source metadata.

The server combines similarity and reliability scores into a composite relevance score, sorts the related information by this score, and removes entries whose score is below a predetermined or dynamically adjusted threshold.

The server keeps only a limited number of high-ranked entries per claim and stores them as organized search result data.

The output of Step 8 is a set of ranked and filtered search result lists, each associated with a verification target of factuality.

### Step 9:

The server generates prompt sentences for evidence summarization and provisional truth classification.

The server takes as input the structured claim records from Step 5 and the organized search result data from Step 8.

The server constructs, for each claim, a prompt sentence including the claim text and a subset of the most relevant snippets, for example: “You are a fact-checking assistant. Given the claim and the web search snippets below, (1) decide whether the evidence mostly supports, mostly contradicts, or is insufficient for the claim, and (2) provide a short explanation. Claim: [claim text]. Snippets: [list of titles and snippets]. Answer concisely in English, indicating one of: ‘supported’, ‘contradicted’, or ‘uncertain’, followed by a brief explanation.” The server sends each prompt sentence to the generative AI model and receives, as output, a generated response containing a classification (supported, contradicted, or uncertain) and a textual explanation.

The output of Step 9 is, for each claim, a generative-model response text that encodes summary information and determination information.

### Step 10:

The server extracts determination information and summary information from the generative-model responses.

The server receives, as input, the generated texts from Step 9 and applies parsing rules and, optionally, a small text classifier to locate the classification label and the accompanying explanation within each response.

The server maps textual labels such as “supported” or “contradicted” into internal status codes, and stores the status codes and explanations in association with the corresponding claim identifiers in a determination data table.

The server thereby generates structured summary information that can be rendered succinctly to the user without requiring additional natural language interpretation.

The output of Step 10 is a set of determination records containing status codes and summary texts for each claim.

### Step 11:

The server assembles response data for presentation on the terminal.

The server takes as input the structured claims from Step 5, the organized search result data from Step 8, and the determination records from Step 10.

The server composes a response data structure that, for each claim, includes the claim text, attribute fields (event, place, time point, quantity), search term sequence, ranked search results, classification status, and explanatory summary.

The server serializes this data structure into a transport format and sends it to the terminal via the network interface.

The output of Step 11 is an aggregated response message containing all relevant information needed for user-facing presentation.

### Step 12:

The terminal receives the aggregated response message from the server and renders it on the display device.

The terminal takes as input the response data structure and parses it into objects or records representing claims and associated evidence.

The terminal draws user interface components for each claim, including text boxes for the claim, labels for the classification status, expandable sections for the explanatory summary, and lists of clickable links for the ranked search results.

The terminal displays these components in a layout that allows the user to scroll, compare multiple claims, and open individual evidence items.

The output of Step 12 is a graphical user interface view showing fact-checking results on the display device.

### Step 13:

The user reviews the displayed claims and evidence and optionally interacts with the interface to refine verification.

The user takes as input the graphical view shown on the terminal, selects a claim that appears ambiguous or important, and manipulates controls such as filters, buttons, or text fields to specify additional constraints or questions.

The user may, for example, restrict results to official sources, focus on a different time range, or request a longer explanation for a particular claim.

The user's operations produce updated instructions that the terminal captures as interaction events.

### Step 14:

The terminal sends refinement instructions to the server for interactive verification.

The terminal takes as input the user's interaction events from Step 13, converts them into a refinement request that includes a target claim identifier and modified parameters such as new search constraints or modified prompt options, and transmits this request to the server.

The terminal may include in the request new text entered by the user, for example an additional keyword or a clarification question.

The output of Step 14 is a refinement request message that instructs the server to perform updated retrieval or summarization for specified claims.

### Step 15:

The server performs updated retrieval and summarization based on the refinement request. The server receives, as input, the refinement request from Step 14, interprets the modified search constraints and prompt options, and regenerates search term sequences or prompt sentences accordingly.

The server re-executes the information retrieval and ranking operations for the targeted claims, and regenerates evidence summaries and classifications if requested, using the same mechanisms as in Steps 6 through 10 but with updated parameters.

The server then assembles updated response data and sends it back to the terminal, allowing the user to see refined results that reflect the interactive adjustments.

The output of Step 15 is an updated response message containing refined search results and updated summaries for the selected claims.

### Step 16:

The server records processing history and uses it for learning-based optimization.

The server takes as input logs of request data, candidate text segments, structured claims, prompt sentences, search term sequences, search results, user interactions, and determination outcomes accumulated over multiple sessions.

The server stores this history information in a dedicated history table, and periodically applies a learning process to adjust parameters or rule sets governing prompt sentence generation and search term sequence generation, for example by computing statistics on which configurations correlate with fewer user corrections or higher user acceptance.

The server updates internal weights, thresholds, or templates used in earlier steps so that future extractions, queries, and summaries are more accurate and efficient, thereby improving the technical performance of the system over time.

The output of Step 16 is an updated set of internal rules and parameters that influence subsequent executions of the program on the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern networked environments, large volumes of textual content, such as articles and posts, are continuously generated and distributed via various information media. Conventional fact-checking workflows depend heavily on manual analysis by human operators or on simple keyword-based search tools. Such approaches suffer from several technical problems in the context of computer-implemented processing.

First, conventional systems do not efficiently transform unstructured character information into machine-usable, structured fact units suitable for automated verification. Many existing tools rely on static rules or shallow keyword extraction, which fail to robustly identify “fact-check-worthy”descriptions embedded in complex sentences, thereby reducing recall and precision from the perspective of information processing.

Second, even when candidate facts are identified, conventional systems do not leverage a coordinated interaction between a generative artificial intelligence model and deterministic natural-language-processing components to generate optimized search queries and to structure search outputs. As a result, the generated search queries are often noisy or incomplete, leading to suboptimal retrieval performance on information retrieval platforms, and forcing the processor to perform additional redundant computations or repeated network accesses.

Third, prior systems do not integrate user emotion signals as first-class input to the computational pipeline. Emotion or sentiment, if used at all, is typically treated as an auxiliary display feature and does not influence the internal prioritization, search depth, or explanation generation. Consequently, processing resources are not adaptively allocated to the most critical facts from the user's perspective, resulting in inefficient use of processing capacity and delayed access to high-value verification results.

Fourth, there is a lack of mechanisms that systematically generate and control prompt sentences supplied to a generative artificial intelligence model such that the model returns machine-readable, structured outputs. Without such control, the processor must perform complex and error-prone post-processing on free-form natural language responses, increasing computational overhead and latency in the end-to-end fact-checking pipeline.

Fifth, existing user interfaces typically present search results in raw or minimally organized form, without a system-level process that computes, for each normalized fact, a relevance score based on similarity, reliability, and temporal information and that synthesizes explicit support/contradiction/neutrality summaries. This forces the user terminal and backend systems to perform repetitive, ad hoc processing, and prevents efficient reuse of intermediate computation results across sessions or users.

Accordingly, there is a need for a computer-implemented system that: (i) systematically converts character information into structured fact information using an integrated pipeline of preprocessing, prompt sentence generation, and generative artificial intelligence output parsing; (ii) generates high-quality search queries from normalized fact information and efficiently interacts with an information retrieval platform; (iii) computes structured relevance and polarity summaries for each fact; and (iv) dynamically adjusts internal priority, query specificity, and explanatory content based on user emotion signals, thereby improving the overall efficiency, accuracy, and responsiveness of computer-based fact-checking operations.

The specific processing by the specific processing unit 290 of the data processing device 12 in Application Example 2 is realized by the following means.

The present invention provides a server comprising a processor configured to acquire character information provided via an information medium; preprocess the acquired character information by segmenting the character information into sentence units and word units and by assigning part-of-speech information and semantic information so as to structure the character information as a symbol sequence; generate, based on the structured character information, a prompt sentence that defines processing contents and an output format for extracting descriptions requiring fact checking; input the generated prompt sentence and the character information to a generative artificial intelligence model that performs natural language processing, and obtain, from the generative artificial intelligence model, an extraction result including candidate descriptions requiring fact checking; for each candidate description included in the extraction result, extract named expressions, quantity expressions, and time expressions, determine consistency with corresponding portions in the character information, and identify descriptions requiring fact checking and organize the identified descriptions as normalized fact information; generate, based on the normalized fact information, a search query including a search term sequence or an interrogative-type search expression for verifying the normalized fact information; transmit a search request including the search query to an information retrieval platform and acquire a search result from an external information source; calculate a relevance score for the acquired search result based on similarity information, reliability information, and time information, and generate, for each piece of the normalized fact information, summary information indicating a degree of support, contradiction, or neutrality; calculate, based on emotional input information acquired from a user, a priority for each piece of the normalized fact information, and control at least one of a presentation order and a degree of emphasis of the summary information and the search result according to the priority; and present the summary information and the search result in a format that is easy for the user to understand, via a display unit of a user terminal. This enables a technical improvement in computer-based fact-checking by transforming unstructured textual input into structured fact units suitable for automated verification, by orchestrating deterministic natural-language processing with a generative artificial intelligence model through controlled prompt sentences to obtain machine-readable outputs, by generating optimized search queries and computing structured support/contradiction summaries for each fact, and by adaptively allocating processing and display resources according to user emotion signals, thereby enhancing processing efficiency, retrieval accuracy, and system responsiveness in a manner not achievable by conventional fact-checking systems.

The term “character information” refers to information represented as a sequence of characters, including text such as articles, posts, comments, or other textual content provided via an information medium.

The term “information medium” refers to a communication environment or platform through which character information is distributed, posted, or accessed, including network services, web sites, applications, or other content delivery systems.

The term “preprocess” refers to performing one or more computational operations on raw character information, such as segmentation, normalization, tokenization, or annotation, in order to convert the character information into a structured form suitable for further processing.

The term “sentence unit” refers to a contiguous portion of character information that corresponds to a sentence or clause determined by syntactic or punctuation-based analysis. The term “word unit” refers to a minimal lexical unit obtained by tokenizing character information, including words, symbols, or other lexical tokens used as basic elements for natural language processing.

The term “part-of-speech information” refers to data indicating grammatical categories assigned to word units, such as noun, verb, adjective, or adverb, used to represent syntactic roles in a sentence.

The term “semantic information” refers to data representing meaning-related attributes of word units or phrases, including roles, relationships, or categories inferred from context.

The term “symbol sequence” refers to a structured representation of character information as an ordered sequence of tokens, each token being associated with one or more annotations such as part-of-speech information and semantic information.

The term “prompt sentence” refers to a control sentence or group of sentences supplied as input to a generative artificial intelligence model, the control sentence specifying a processing task, constraints, and an output format expected from the model.

The term “generative artificial intelligence model” refers to a machine-learned model configured to generate or transform natural language or structured data based on input information, including models that produce textual outputs according to prompt sentences.

The term “natural language processing” refers to a class of computational techniques for analyzing, generating, or transforming human language, including tokenization, parsing, semantic analysis, and text generation.

The term “extraction result” refers to data output by the generative artificial intelligence model in response to a prompt sentence, the data including one or more candidate descriptions, annotations, or other elements identified as relevant to a specified task.

The term “candidate description” refers to a portion of character information, such as a sentence or phrase, that is identified as potentially requiring fact checking or verification.

The term “description requiring fact checking” refers to a candidate description that has been determined, through analysis, to contain a factual claim or assertion that is to be verified against external information sources.

The term “named expression” refers to an expression that denotes a specific entity, such as a person, organization, geographic location, product, or event, recognized through named entity analysis.

The term “quantity expression” refers to an expression that represents a numeric value or measurable amount, including numbers, percentages, counts, or other quantitative indicators. The term “time expression” refers to an expression that indicates a temporal attribute, such as a date, time of day, period, or temporal relation.

The term “normalized fact information” refers to structured data representing a description requiring fact checking, the structured data including cleaned and standardized elements such as entities, quantities, and temporal attributes.

The term “search query” refers to a data structure used to request information from an information retrieval platform, the data structure including a search term sequence and/or an interrogative-type search expression derived from normalized fact information.

The term “search term sequence” refers to an ordered combination of one or more terms, keywords, or phrases configured to retrieve information relevant to a fact when processed by an information retrieval platform.

The term “interrogative-type search expression” refers to a search query expressed in a question-like form, typically formulated as a natural-language question intended to retrieve information that answers or evaluates a fact.

The term “information retrieval platform” refers to a computational system configured to receive search queries and return search results, including search engines, database systems, or index-based retrieval systems.

The term “search result” refers to information returned by an information retrieval platform in response to a search query, including document identifiers, titles, snippets, links, timestamps, or other metadata.

The term “similarity information” refers to data indicating a degree of similarity between an element of normalized fact information and a search result, such as textual similarity or semantic similarity metrics.

The term “reliability information” refers to data representing an estimated trustworthiness or quality of a source or search result, which may be determined based on source type, historical behavior, or predefined criteria.

The term “time information” refers to data representing temporal attributes associated with search results or facts, including publication times, event times, or retrieval times.

The term “relevance score” refers to a numerical or categorical value computed for a search result, the value indicating how strongly the search result relates to a piece of normalized fact information based on similarity information, reliability information, and time information.

The term “summary information” refers to synthesized data generated for a piece of normalized fact information, the synthesized data indicating a degree of support, contradiction, or neutrality with respect to the fact based on one or more search results.

The term “degree of support” refers to an indication that search results collectively tend to confirm or agree with a piece of normalized fact information.

The term “degree of contradiction” refers to an indication that search results collectively tend to refute or conflict with a piece of normalized fact information.

The term “degree of neutrality” refers to an indication that search results neither clearly support nor clearly contradict a piece of normalized fact information, or provide mixed or inconclusive evidence.

The term “emotional input information” refers to data obtained from a user that expresses or implies an emotional state, including textual comments, voice inputs, or other interaction signals.

The term “priority” refers to a value indicating an order of importance or processing preference assigned to each piece of normalized fact information, the value being used to control allocation of computational resources and presentation order.

The term “presentation order” refers to an arrangement or sequence in which summary information and search results are displayed to a user.

The term “degree of emphasis” refers to a level or manner of visually or otherwise highlighting summary information or search results, including use of colors, sizes, positions, or symbols.

The term “user terminal” refers to an end-user device configured to communicate with the server, including a terminal device such as a mobile device, a wearable device, or a stationary computing apparatus.

The term “display unit” refers to a hardware and software component of a user terminal that outputs visual information to a user, such as a screen, monitor, or graphical user interface.

In one embodiment, a server includes at least one processor, a memory, a network interface, and a non-transitory computer-readable medium storing instructions. The server is connected via a communication network to one or more terminals. The terminal includes a display unit, an input unit, a communication interface, and optionally an audio capture device. A user operates the terminal to access character information distributed via an information medium, such as a network-accessible content platform.

The server executes software modules that implement natural language preprocessing, prompt sentence generation, interaction with a generative AI model, post-processing of outputs from the generative AI model, search query generation, communication with an information retrieval platform, relevance and polarity scoring, emotion analysis, priority control, and presentation control. The server executes these modules under an operating system running on the processor. The processor may be a general-purpose microprocessor or a multicore processor located in a data center. The memory may be a volatile memory storing intermediate data structures, and the non-transitory medium may be a disk or solid-state storage storing model parameters and program binaries.

The server uses a natural language processing library, such as a pipeline-based parser, to segment character information into sentence units and word units and to assign part-of-speech information and semantic information. The server uses a machine learning framework, such as a tensor-based computation library, to implement embedding models, classification models, and neural network computations. The server communicates with an external generative AI model via an application programming interface. The generative AI model may be implemented as a transformer-based neural network having multiple self-attention layers, feed-forward layers, and layer normalization, trained on large-scale text corpora. The server further uses an emotion analysis library to compute sentiment and emotional labels from user input.

The server stores internal data in structured data structures. For example, the server stores each article received from the terminal as an “article object” containing a unique identifier, raw character information, and a list of sentence objects. Each sentence object contains a string, token list, part-of-speech tags, dependency relations, and named expressions. The server stores fact candidates in a “fact list,” where each fact entry includes a reference to at least one sentence object, a claim summary string, a list of entity identifiers, a list of quantity expressions, a list of time expressions, and an initial priority value. The server stores search-related information in a “search result object,” which contains search query strings, a list of retrieved document records, and computed scores. These structured data representations allow the server to avoid repeated parsing and to operate on compact, indexed structures rather than raw text, thereby reducing processor load and memory movement.

The server uses the natural language preprocessing module to transform raw character information into a symbol sequence. This transformation includes applying tokenization, sentence boundary detection, part-of-speech tagging, named entity recognition, and dependency parsing. The server assigns each token an index, a part-of-speech label, and embedding indices, and stores these values in arrays. By representing the text as indices into shared vocabularies, the server reduces memory consumption and increases cache locality, which improves processing speed.

The server generates a prompt sentence for each article or set of sentences. The server constructs the prompt sentence by inserting context information derived from the symbol sequence. For example, the server extracts key entities and quantities from the article and inserts them into a template such as:
“From the following article, extract all statements that contain factual claims which may require fact checking. For each statement, output: (1) the exact sentence, (2) a short description of the claim, and (3) key entities and numbers involved.”

The server may add additional constraints to force the generative AI model to return a structured and machine-readable format, such as:
“Return the output as a list of items, where each item includes: ‘sentence:’, ‘claim_summary:’, ‘entities:’, and ‘numbers:’.”

The server also generates prompt sentences for emotion-aware prioritization and explanation synthesis. For example, the server may generate:
“Given this claim, the user's reaction text, and these web search snippets, decide whether this claim should be treated as high, medium, or low priority for fact checking. Explain your reasoning briefly.”
and
“Using the following claim and the retrieved web sources, write a concise explanation for a general user. Indicate whether the claim is supported or contradicted, name the most credible sources, and explain any differences in the reported numbers.”

By systematically constructing prompt sentences with explicit formatting instructions and contextual metadata, the server constrains the generative AI model's output, thereby reducing ambiguity and post-processing complexity. This control of the prompt sentence is a computer-centric mechanism that improves the reliability and efficiency of the interaction between the server and the generative AI model.

The server transmits the generated prompt sentence and relevant character information to the generative AI model via the network interface. The server packages the prompt sentence and the article text as a request payload and sends it over a secure application protocol. The generative AI model, implemented as a multi-layer transformer neural network with attention mechanisms, processes the tokenized input. The input tokens include both prompt tokens and article tokens. The model internally computes contextualized embeddings and outputs tokens representing the extraction result. The model uses learned parameters obtained through supervised or self-supervised training, and the server can store a version identifier of the model to ensure reproducible behavior.

The server receives the output text from the generative AI model and applies deterministic parsing rules to convert the output into the fact list. The server uses delimiters and labels specified in the prompt sentence (e.g., “sentence:”, “claim_summary:”, “entities:”, “numbers:”) to split the output into structured fields. The server uses string matching and token overlap between each candidate description and the original sentences to verify alignment with the article. This alignment process includes computing token-level Jaccard similarity and edit distance. If a candidate description does not meet a threshold similarity to any source sentence, the server discards it. This verification step reduces model hallucinations and improves the precision of the fact list.

The server then performs an additional analysis on each candidate description using deterministic natural language processing and machine-learned classifiers running on the processor. For example, the server applies a classification model implemented as a feed-forward neural network that takes as input features such as sentence length, presence of quantities, presence of named expressions, and syntactic patterns, and outputs a probability that the sentence is a fact-check-worthy description. The server also applies rules that filter out sentences with purely subjective markers (e.g., “I think,” “in my opinion”) or non-informative content. Through this hybrid approach, combining the generative AI model and deterministic analysis, the server generates normalized fact information that is both semantically rich and computationally stable.

The server generates one or more search queries for each piece of normalized fact information. The server constructs search term sequences by combining entities, quantities, and time expressions into ordered lists of keywords, such as:
“city_name new infection cases yesterday over 1000 official statistics”

The server can also construct interrogative-type search expressions such as:
“Did the number of new infection cases in the specified city exceed 1000 yesterday?”

The server uses term weighting algorithms to emphasize entities and quantities and to de-emphasize function words. The server may embed each query into a vector space using a neural embedding model, and may expand or refine query terms by selecting near neighbors in the embedding space. These steps reduce the number of irrelevant search results and decrease the number of repeated network accesses to the information retrieval platform.

The server transmits each search query to an information retrieval platform, such as a search engine or index-based system, using standardized query formats. The server sends queries batched by article or by user session to reduce round-trip times and network overhead. The information retrieval platform returns a set of search results, each including at least a document identifier, a title, a snippet of text, a source address, and a timestamp. The server associates each search result set with the corresponding normalized fact information and stores them together in the search result object.

The server computes, for each search result, a relevance score based on similarity information, reliability information, and time information. The server may represent similarity information as a cosine similarity value between the embedding of the normalized fact information and the embedding of the snippet. The server may represent reliability information as a numerical score derived from source categories (e.g., governmental domain, recognized news provider, unknown site) and historical performance. The server may represent time information as a decay function of the difference between the article time and the document time. The server combines these values into a composite relevance score using a weighted sum or a learned ranking model. By applying this composite scoring at the server side, the system reduces the volume of low-value data transmitted to the terminal and reduces the processing burden on the terminal.

The server generates summary information for each piece of normalized fact information by aggregating the relevance scores and textual content of the top-ranked search results. The server applies a classifier that estimates whether the external evidence supports, contradicts, or is neutral with respect to the fact. For instance, the server can use a neural network that takes as input the concatenation of a fact representation and a result snippet representation and outputs a probability distribution over the categories “support,” “contradiction,” and “neutral.” The server then aggregates these probabilities across results to compute a degree of support, contradiction, or neutrality. The server encodes this degree as summary information that can be easily interpreted by the terminal and the user.

The server also processes emotional input information received from the terminal. The terminal captures a user's text comment or voice input associated with a particular article or fact. If the input is voice, the terminal transforms it into text using a speech recognition engine executing locally on the terminal or via a remote service. The terminal transmits the text and metadata (e.g., associated fact identifier, timestamp) to the server. The server executes an emotion analysis algorithm on the processor, which may include lexicon-based sentiment scoring, feature extraction, and classification via a neural network. For example, the server may use as features sentiment polarity, the presence of emotion-laden words, intensity markers, and punctuation patterns. The server outputs an emotional state label, such as “unbelievable,” “concerned,” or “angry,” and associates this label with one or more pieces of normalized fact information.

The server calculates a priority value for each piece of normalized fact information based on the emotional state label and on other factors, such as the degree of contradiction and reliability scores. The server can implement this calculation using a rule-based weighting mechanism or a trainable model. For example, when the emotional state label indicates skepticism and the degree of contradiction is high, the server assigns a higher priority value. The server stores these priority values and uses them to order facts and to control visual emphasis. Because these operations are performed by the processor using explicit rules and learned mappings, the prioritization is deterministic and reproducible, and the server can dynamically focus computational resources (such as additional searches or explanation generation) on high-priority facts.

The terminal receives from the server a data structure containing normalized fact information, search results, summary information, and priority values. The terminal uses its processor and display unit to render the information to the user. The terminal overlays fact indicators next to sentences in the displayed article and, when the user selects a fact, opens a panel showing summary information and links to external sources. The terminal uses the priority values and emphasis indicators from the server to control visual design, such as ordering entries in a list, coloring high-priority facts differently, or enlarging icons. This coordinated control between server and terminal reduces the amount of layout computation on the terminal and allows the server to tailor presentation behavior according to user emotions and fact importance.

The user interacts with the terminal by reading articles, selecting fact indicators, entering comments, and optionally requesting additional explanations. When the user requests more detailed information, the terminal forwards this request and context to the server. The server may then generate a new prompt sentence for explanation synthesis by the generative AI model, such as:
“Given the following claim and the listed web search results, answer the user's question. Focus on reliability, explain disagreements between sources, and suggest the most trustworthy conclusion.”

By offloading the explanation synthesis to the generative AI model and constraining it with context and instructions, the server generates tailored explanations without requiring extensive hand-coded templates. The server's control over the format and content of these explanations contributes to an improved user experience and reduces the need for manual editorial intervention.

This overall configuration provides technical effects beyond mere automation of human fact-checking. The server uses specific data structures, staged processing, controlled prompt sentences, and combined generative and deterministic algorithms to improve processing speed and accuracy. For example, by structuring character information as symbol sequences with indices and annotations, the server reduces repeated parsing and enables efficient reuse of intermediate results. By constraining the generative AI model with well-designed prompt sentences and post-processing rules, the server transforms the model outputs into machine-readable, low-noise representations, which reduces downstream error rates and correction cost. By computing composite relevance scores and aggregating support/contradiction degrees on the server, the system reduces the number of irrelevant documents sent over the network, thereby lowering communication load. By integrating emotion-based prioritization, the server avoids unnecessary deep analysis for low-impact facts and reallocates computation to high-priority cases, increasing effective throughput.

The generative AI model in this system operates according to non-conventional rules and flows defined by the server. The server does not simply request generic summaries from the model; instead, the server encodes explicit structural requirements, filtering criteria, and context selection strategies in the prompt sentences. The server combines these model outputs with additional classifiers and rule-based modules that use engineered features and learned parameters. The server trains or uses trained models with defined loss functions, such as cross-entropy for classification of fact-check-worthiness and support/contradiction, and updates weights using gradient-based optimization. The server can apply data augmentation techniques, such as paraphrasing claims or simulating user reactions, to improve model robustness. These technical measures show that the system modifies and improves how a computer processes and manages large-scale textual data and fact-checking tasks.

Alternative embodiments may use different neural architectures for the generative AI model, such as encoder-decoder transformers, recurrent neural networks with attention, or hybrid models that combine rule-based extraction and neural ranking. The server may execute at least part of the neural inference locally or may offload it to specialized hardware accelerators. The emotion analysis component may be implemented as a convolutional network, a recurrent network, or a transformer trained on emotion-labeled text corpora. The information retrieval platform may be an external search engine or an internal index built using an inverted index structure and term frequency-inverse document frequency statistics, possibly enhanced with learned ranking models.

In another embodiment, the terminal may perform a subset of the preprocessing and emotion analysis to reduce server load. For example, the terminal may tokenize text locally and send pre-tokenized data, or may perform initial sentiment scoring and transmit an emotion label rather than raw text. In another embodiment, the server may cache normalized fact information and search results for frequently accessed articles, enabling reuse across users and sessions and further reducing latency and network traffic.

By providing these specific hardware configurations, software modules, data structures, and algorithmic flows, the system concretely improves computer technology as applied to large-scale, emotion-aware fact checking, rather than merely implementing an abstract idea or business method. The server, the terminal, and the user cooperate in a way that leverages generative AI models and prompt sentences as controlled tools within a structured computational pipeline, thereby achieving enhanced speed, accuracy, and resource utilization in real-world deployment environments.

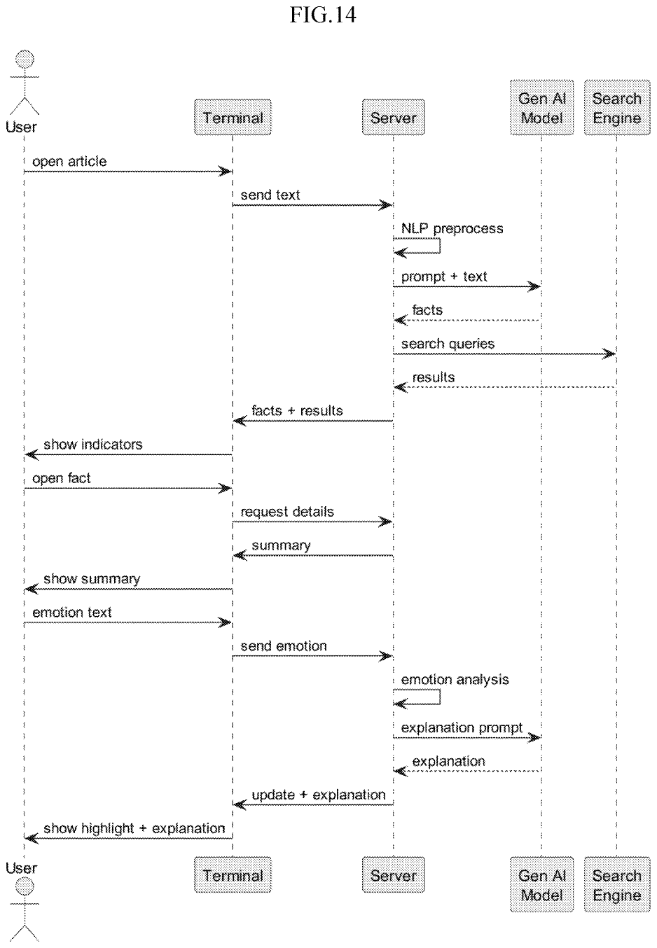

The following describes the processing flow using FIG. 14.

### Step 1:

User opens an article on the terminal.

User selects or navigates to a piece of character information, such as a news article or post, using an application executing on the terminal.

Input: Article identifier, article URL, or raw article text obtained by the terminal application.

Output: Displayed article content on the terminal screen and an internal representation of the article text stored in the terminal's memory.

Terminal retrieves the article text from an information medium (for example, a content server) and renders the character information on the display unit. The terminal creates an internal buffer containing the full article text and associated metadata (for example, language, source, and timestamp), which will be sent to the server for processing.

### Step 2:

Terminal transmits character information to the server.

Terminal packages the article text and metadata into a request message and sends the request to the server via a network interface using a secure communication protocol.

Input: Internal article buffer (text and metadata) stored in the terminal.

Output: Network request payload delivered to the server, including article text, metadata, and user/session identifiers.

Terminal may compress the text data, add a session token, and include a device identifier.

Terminal then transmits the payload and sets a local state flag indicating that fact-check analysis for this article is “in progress.”

### Step 3:

Server receives and stores character information.

Server accepts the network request via its communication interface, verifies authentication, and stores the received article text in a persistent or temporary storage system.

Input: Network payload containing article text, metadata, and session identifiers from the terminal.

Output: Article object stored in server memory or database, including a unique article ID and raw character information.

Server parses the payload headers, validates the format, and assigns a new article ID. Server stores the raw text and metadata in structured form, such as an article table or document store, and registers a fact-check processing task associated with the article ID.

### Step 4:

Server performs natural language preprocessing.

Server executes a natural language preprocessing pipeline on the article text to convert unstructured character information into a structured symbol sequence.

Input: Raw article text associated with the article ID.

Output: Structured representation including sentence list, token list, part-of-speech tags, dependency relations, and named expressions.

Server segments the text into sentence units using punctuation and statistical language models. Server tokenizes each sentence into word units, assigns part-of-speech tags, and performs dependency parsing with a natural language processing library. Server identifies named expressions such as locations, organizations, and persons. Server stores all annotations in a data structure indexed by article ID and token positions.

### Step 5:

Server generates a prompt sentence for fact extraction.

Server constructs a prompt sentence that specifies how the generative AI model should extract descriptions requiring fact checking from the article.

Input: Structured representation of the article, including sentences, entities, and quantities. Output: Prompt sentence text that encodes extraction instructions and desired output format. Server selects representative sentences, extracts key entities and quantities, and embeds them into a template, for example:
“From the following article, extract all statements that contain factual claims which may require fact checking. For each statement, output: (1) the exact sentence, (2) a short description of the claim, and (3) key entities and numbers involved. Return the output as a list of items, where each item includes: ‘sentence:’, ‘claim_summary:’, ‘entities:’, and ‘numbers:’”

Server concatenates the prompt sentence and the raw article text to form an input string for the generative AI model.

### Step 6:

Server submits the prompt sentence and article text to the generative AI model.

Server invokes an external or internal generative AI model through an application programming interface, sending the composed input string.

Input: Prompt sentence text and article text combined into a model input sequence.

Output: Model output text representing an extraction result that lists candidate descriptions and associated elements.

Server tokenizes the combined input according to the model's vocabulary and sends the token sequence to the generative AI model. Server waits for the model to generate output tokens, receives the generated text, and logs the model call for traceability.

### Step 7:

Server parses the generative AI model output into candidate descriptions.

Server interprets the output text returned by the generative AI model and extracts structured information for each candidate description.

Input: Model output text containing items labeled with fields such as “sentence:”, “claim_summary:”, “entities:”, and “numbers:”.

Output: Fact list comprising structured candidate descriptions, each with sentence string, claim summary, entity list, and number list.

Server scans the output text, detects field labels, and splits the text into segments. Server assigns each segment to corresponding fields, trims whitespace, and converts entity and number strings into lists. Server discards incomplete entries that do not contain a sentence field and stores the resulting fact list linked to the article ID.

### Step 8:

Server verifies alignment between candidate descriptions and original sentences.

Server ensures that each candidate description corresponds to one or more sentences in the original article.

Input: Fact list with candidate sentences and original article sentence list.

Output: Filtered fact list where each candidate description is mapped to a specific sentence index and invalid items are removed.

Server computes similarity scores between each candidate sentence and each article sentence using token overlap or string similarity metrics. Server selects the article sentence with the highest similarity above a threshold and records the mapping. If no sentence passes the threshold, the server removes the candidate from the fact list. This verification reduces misaligned or hallucinated outputs.

### Step 9:

Server converts verified candidate descriptions into normalized fact information.

Server refines each verified candidate description to create normalized fact information that is consistent and machine-usable.

Input: Verified fact list with mapped sentences and extracted entities and numbers.

Output: Normalized fact information list including sentence reference, standardized entities, standardized quantities, standardized time expressions, and an initial priority value.

Server resolves entity names to canonical forms (for example, standardizing location names), normalizes numeric formats (for example, converting “1,000” and “one thousand” into a standard numeric representation), and parses time expressions into structured timestamps or date ranges. Server assigns each fact an initial neutral priority and stores the normalized fact information in a dedicated data structure.

### Step 10:

Server generates search queries from normalized fact information.

Server constructs search queries designed to retrieve evidence that can verify or refute each normalized fact.

Input: Normalized fact information list containing entities, quantities, and time expressions.

Output: Search query list including keyword sequences and, optionally, interrogative-type search expressions for each fact.

Server concatenates entity names, key nouns, quantities, and time expressions into keyword-style queries and formats question-like sentences from the claim summaries. Server may calculate term weights and order terms to emphasize important features. Server stores the search queries along with references to the corresponding fact identifiers.

### Step 11:

Server transmits search queries to an information retrieval platform and receives search results.

Server interacts with a search engine or database to obtain external evidence related to each fact.

Input: Search query list with associated fact identifiers.

Output: Raw search result sets containing documents, titles, snippets, links, and timestamps for each query.

Server sends each query to the information retrieval platform, either individually or in batches. Server receives search results, parses the response format, and stores the results in search result objects. Server associates each search result object with the corresponding fact identifier for later aggregation.

Step 12: Server computes relevance scores and generates summary information.

Server evaluates search results for each fact and summarizes the overall degree of support, contradiction, or neutrality.

Input: Search result objects and normalized fact information.

Output: For each fact, a relevance-ranked list of results and a summary indicating the degree of support, contradiction, or neutrality.

Server computes similarity measures between fact text and result snippets, assigns reliability scores based on source attributes, and evaluates time proximity using timestamps. Server combines these metrics into a composite relevance score and ranks results accordingly.

Server then applies a classification algorithm to estimate whether the set of results supports or contradicts the fact and encodes this estimation as summary information linked to each fact.

### Step 13:

Terminal receives and displays initial fact-check information.

Terminal obtains the fact information, search results, and summary data from the server and integrates them into the user interface.

Input: Response payload from the server containing normalized fact information, ranked search results, and summary information per fact.

Output: Visual indicators in the article view and an interface for fact-detail panels on the terminal display.

Terminal maps each fact's sentence reference to a location within the article text and overlays icons or highlights. When the article is displayed, the terminal shows subtle markers indicating that fact-check information is available. Terminal stores the received fact data in local memory for interactive display.

### Step 14:

User inspects fact-check indicators and opens detailed panels.

User taps or clicks an indicator associated with a particular sentence to see the fact-check details.

Input: Displayed article with fact indicators and user input events (taps, clicks, or gestures). Output: Opened detail panel on the terminal showing summary information and related external sources.

Terminal detects the user's interaction, identifies the corresponding fact identifier, and retrieves the fact's summary information and top-ranked search results from local memory. Terminal renders a panel or overlay containing the original sentence, the claim summary, the support/contradiction summary, and links to external documents.

### Step 15:

User provides emotional input related to a claim.

User expresses an emotional reaction to a claim by entering text or speaking a comment, such as “I can't believe this number.”

Input: User's emotional reaction via a text input field or voice capture interface on the terminal.

Output: Emotional comment text associated with a selected fact and a user session identifier. Terminal captures the comment, associates the comment with the current article and, if applicable, a specific fact identifier, and stores the comment locally until it is sent to the server.

### Step 16:

Terminal transmits emotional input information to the server.

Terminal sends the user's emotional comment and related metadata to the server for analysis. Input: Emotional comment text, article ID, fact ID, and session information stored on the terminal.

Output: Network request containing emotional input information delivered to the server.

If the comment is spoken, the terminal converts audio to text using a speech recognition routine before transmission. Terminal packages the resulting text and identifiers into a message and sends it to the server via the communication interface.

### Step 17:

Server analyzes emotional input information.

Server interprets the emotional content of the user's comment to determine the user's emotional state regarding a fact.

Input: Emotional comment text and associated metadata (article ID, fact ID).

Output: Emotional state label and, optionally, an intensity score linked to one or more facts. Server applies an emotion analysis algorithm that extracts features such as sentiment polarity, presence of emotion-related words, and emphasis markers. Server then classifies the comment into labels such as “unbelievable,” “concerned,” or “neutral” and stores this label with a reference to the corresponding fact identifier in the server's emotion state data.

### Step 18:

Server updates priorities and presentation control information.

Server adjusts the priority of each fact based on the emotional state and existing support/contradiction data.

Input: Emotional state labels, normalized fact information, and summary information. Output: Updated priority values and emphasis parameters (for example, highlight level) for each relevant fact.

Server computes new priority values using a combination of rule-based logic and score weighting. For example, if the emotional state label is “unbelievable” and the summary information indicates contradiction, the server increases the priority. Server encodes this new priority and sets presentation-related flags (such as “highlight strongly” or “show first”) for each affected fact.

### Step 19:

Server optionally generates an explanation prompt sentence and requests explanation from the generative AI model.

Server prepares a new prompt sentence to obtain a user-friendly explanation of the evidence surrounding a specific fact.

Input: Target fact text, associated search snippets, and, optionally, the user's emotional comment.

Output: Explanation prompt sentence and a request payload for the generative AI model. Server composes a prompt such as:
“Using the following claim and the retrieved web sources, write a concise explanation for a general user. Indicate whether the claim is supported or contradicted, name the most credible sources, and explain any differences in the reported numbers.” Server concatenates the claim, the main snippets, and this prompt sentence, sends the combined text to the generative AI model, and receives an explanatory response.

### Step 20:

Server returns updated fact data and optional explanations to the terminal.

Server constructs a response containing revised priorities, emphasis parameters, and any generated explanations.

Input: Updated priority values, emphasis parameters, and explanation text produced by the generative AI model.

Output: Response payload with updated fact metadata and explanations sent to the terminal. Server encodes the updated information into a structured response associated with the article ID and sends it via the network. Server may also update internal logs for monitoring and analysis.

### Step 21:

Terminal refreshes the display based on updated priorities and explanations.

Terminal renders the article view with updated visual emphasis and additional explanatory content.

Input: Response payload from the server containing updated priority values, emphasis parameters, and explanations.

Output: Updated article display showing reordered or highlighted facts and optional explanation sections.

Terminal re-sorts any fact lists in side panels, adjusts icon colors or sizes for high-priority facts, and inserts explanation text into expandable sections under each relevant fact. Terminal then redraws the user interface so that the user sees emphasized, high-priority fact-check results and can read generated explanations.

### Step 22:

User reviews updated fact-check results and explanations.

User inspects the highlighted facts, reads the explanations, and may further refine their assessment of the article's reliability.

Input: Updated article view with emphasized facts and explanation panels, visible on the terminal display.

Output: User's internal judgment and any subsequent actions, such as closing the article, sharing the analysis, or requesting additional information.

User can follow links to external sources, compare contradictory evidence, and, if desired, provide additional comments or questions, which will again be processed by the terminal and the server according to the previous steps.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

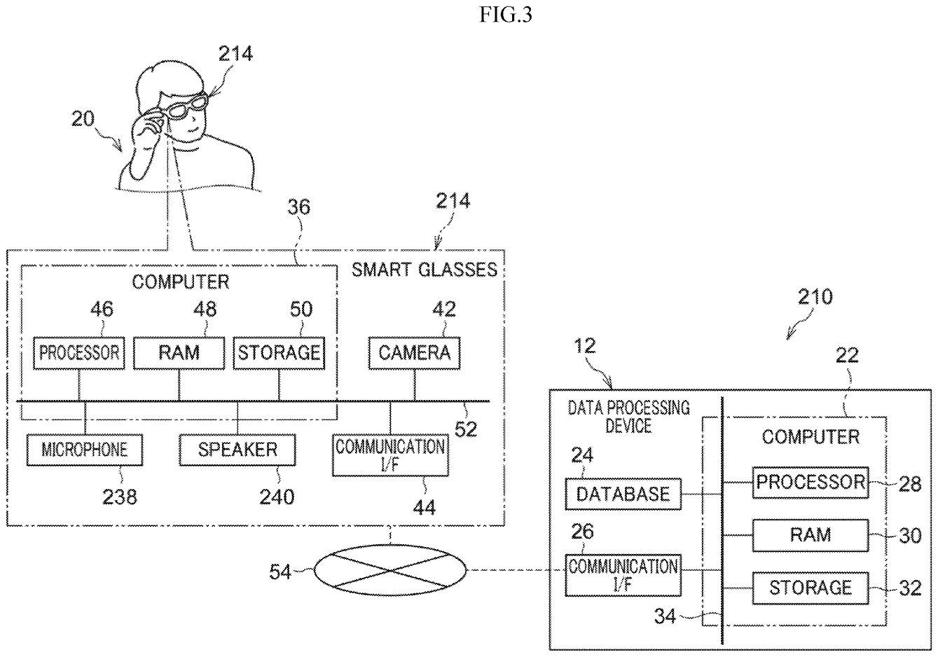

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

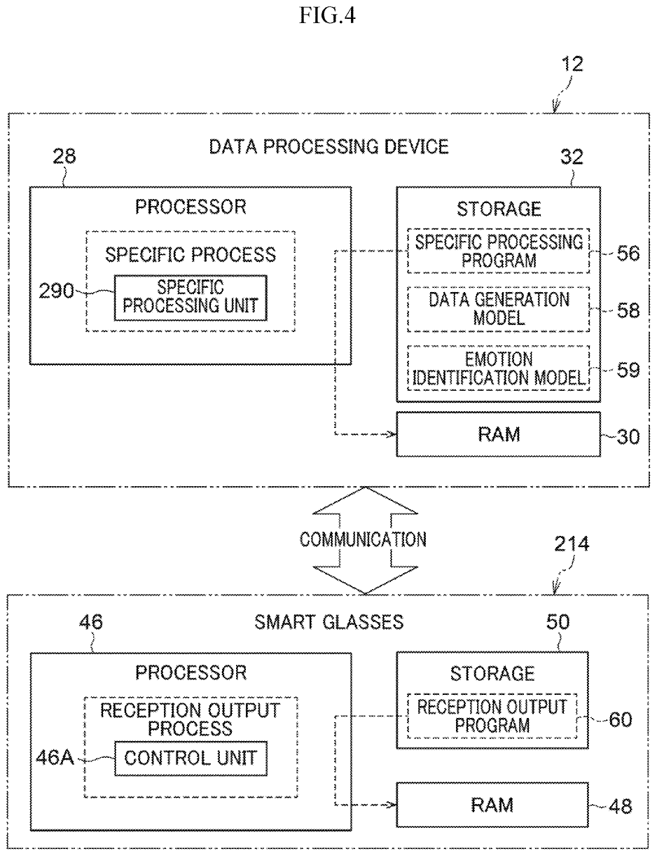

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

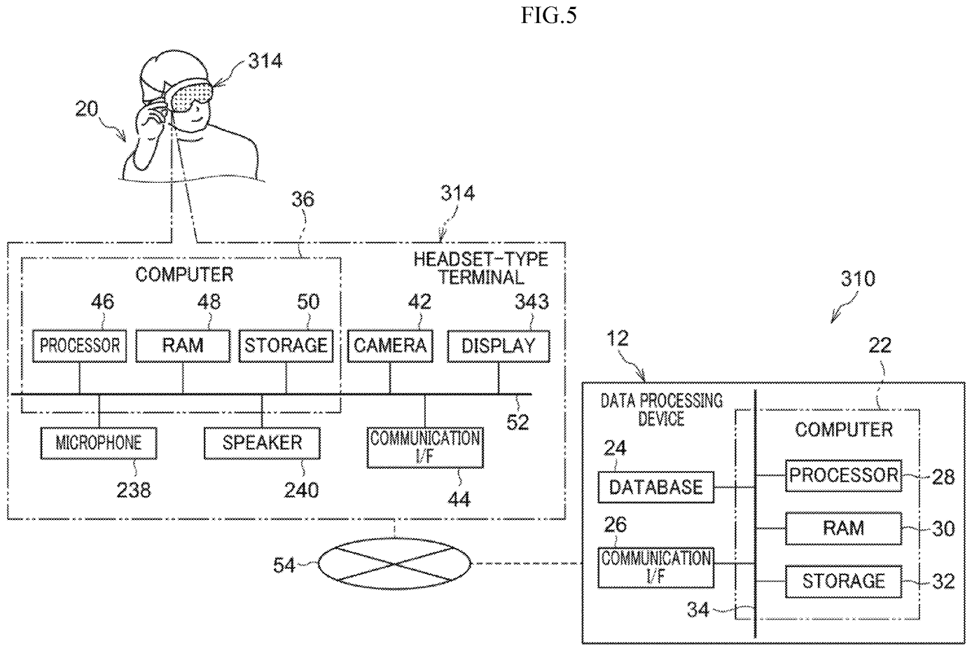

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

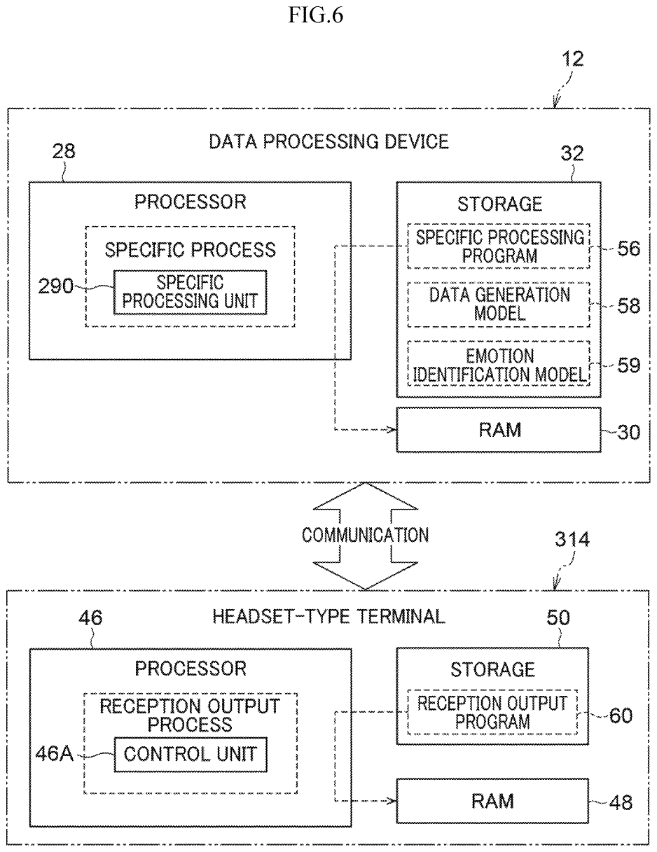

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

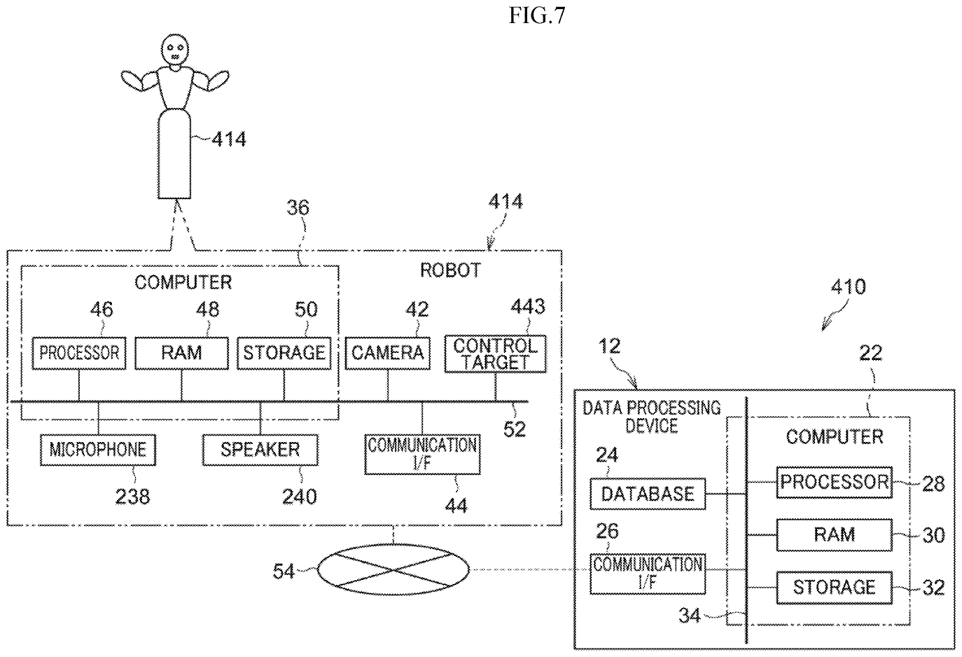

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

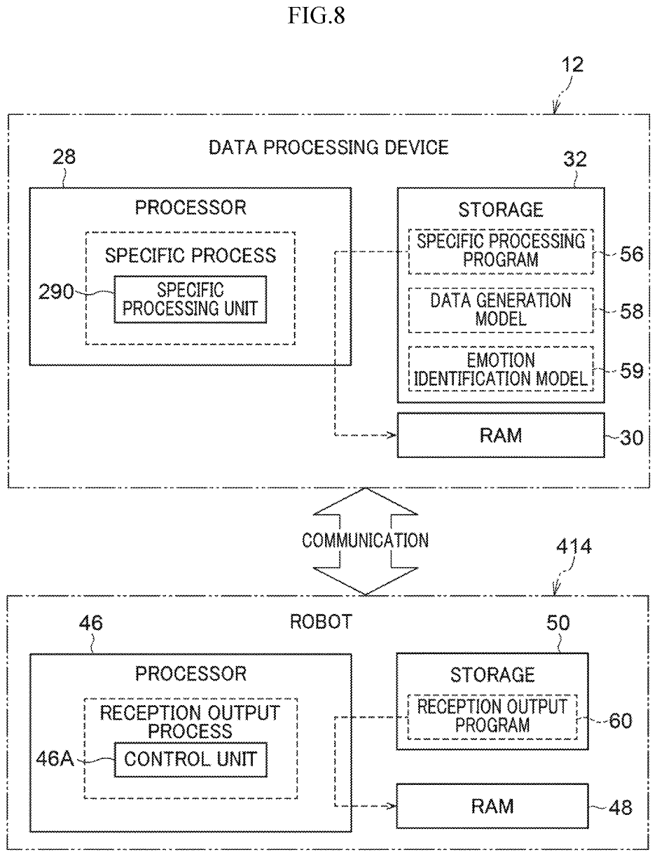

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

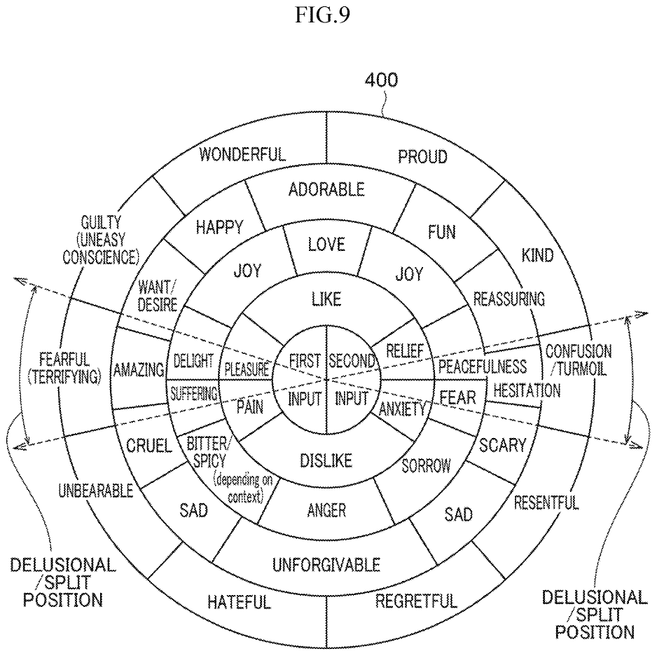

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

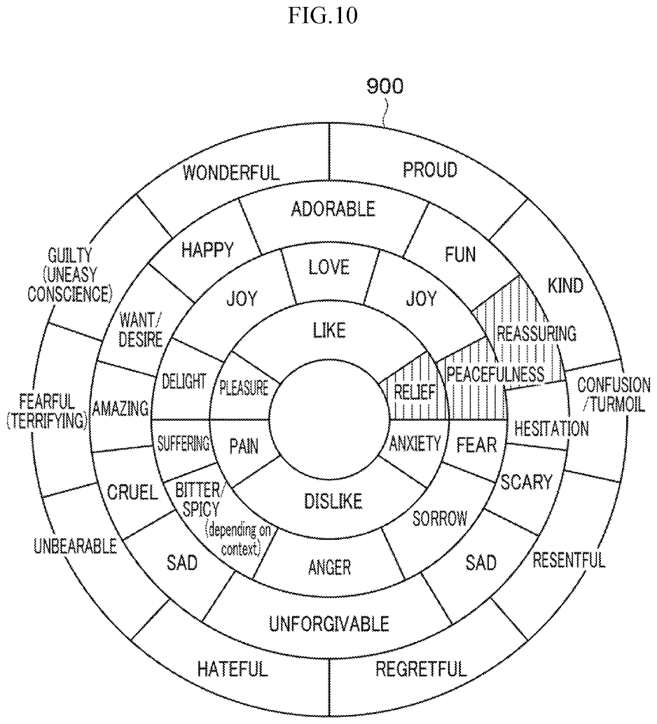

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information posted on an information distribution platform;
analyze the received character information and generate a prompt sentence including an instruction content for extracting candidate information including content requiring fact checking;
input the prompt sentence into a generative information processing model and automatically extract information requiring fact checking corresponding to the candidate information;
generate a search character string representing a fact to be verified, based on the extracted information;
transmit the search character string to an external information search platform and execute an acquisition process for related information;
aggregate the acquired related information in association with the extracted information and generate display data structured so that a user can evaluate correctness of the fact; and
present the display data via a user interface.

### Supplementary 2

The system according to supplementary 1,
wherein the processor is configured to
automatically generate the prompt sentence including the instruction content for extracting the candidate information and the search character string, based on a response generated by the generative information processing model, and instruct the generative information processing model to generate at least elements of the candidate information, search conditions, and a summary for explanation to the user.

### Supplementary 3

The system according to supplementary 1,
wherein the processor is configured to
manage identification information indicating a correspondence between the information requiring fact checking extracted from the character information and the related information, record an evaluation result of the user input via the user interface in association with the identification information, and use a record content as learning data for updating at least one of an extraction process of the candidate information and an acquisition process of the related information.

### Application Example 1

### Supplementary 1

A system comprising a processor,
wherein the processor is configured to
acquire character information included in an information medium being browsed by a user from a terminal device via a communication line,
extract, by natural language processing using a machine learning model, candidate information requiring fact-checking from text included in the acquired character information, and generate a prompt sentence for instructing a generative AI model to perform such extraction processing,
input the generated prompt sentence to the generative AI model, automatically extract the candidate information requiring fact-checking, and select, from the candidate information, information satisfying a predetermined condition as fact-check target information,
analyze event information, quantitative information, time information, and geographic information included in the fact-check target information, and construct search terms and generate search query data based on the search terms,
execute an information search process for an external information search service using the search query data and acquire search result data,
associate the acquired search result data with the fact-check target information on a per-item basis, convert the associated data into structured data, and generate display data to be transmitted to the terminal device, and
cause, based on the display data, the terminal device to present, in a display area of the terminal device, the fact-check target information and corresponding search result information in association with each other, thereby enabling the user to refer to the search result information and determine credibility of the fact-check target information.

### Supplementary 2

The system according to supplementary 1,
wherein the processor is configured to
use, as the machine learning model, a natural language processing model, divide the character information into unit sentences or word sequences, calculate an evaluation index relating to factuality for each of the unit sentences or word sequences, extract the candidate information requiring fact-checking based on the evaluation index, and generate the prompt sentence including extraction conditions and a target range.

### Supplementary 3

The system according to supplementary 1,
wherein the processor is configured to
generate the display data, when transmitting the display data to the terminal device, as a data structure including position information of character strings of the fact-check target information, summary information of the search result information, and a relevance index, and cause the terminal device to highlight, on a display screen, a text region corresponding to the position information of the character strings and to display, in association with the text region, the search result information in a hierarchical or list format.

### Example 2

### Supplementary 1

A system comprising a processor and a memory, the system being connected to a display device and an input device,
wherein the processor is configured to
receive, via the input device, character information distributed through an information delivery service,
mechanically extract, from the character information, candidate text segments representing descriptions requiring verification of factuality, by using a natural language processing algorithm and a statistical learning model,
generate, on the basis of the candidate text segments and the character information, a prompt sentence including instruction content for a generative AI model so as to confirm the candidate text segments as structured factual information, input the prompt sentence into the generative AI model, automatically extract information requiring verification of factuality, and obtain an extraction result as structured data including attribute information,
generate a search term sequence on the basis of elements included in the structured data, the elements comprising a target event, a place, a time point, and a quantity, and transmit a search request including the search term sequence to an information retrieval function so as to execute acquisition processing of related information,
perform, on the related information, ranking processing and unnecessary information elimination processing according to importance by using a similarity calculation algorithm and a reliability evaluation rule, and generate search result data organized for each verification target of factuality,
generate, on the basis of the search result data and the structured data as summarization target information, a prompt sentence including instruction content for the generative AI model so as to generate an explanatory text indicating evidential relationships and a provisional truth classification, input the prompt sentence into the generative AI model, and obtain summary information and determination information, and
present the summary information, the determination information, and the search result data, via the display device, in a format that allows a user to easily compare and verify the information.

### Supplementary 2

The system according to supplementary 1,
wherein the processor is configured to store, in the memory as history information, the information requiring verification of factuality extracted from the character information and the related information, and to perform a learning process for updating a generation rule for the prompt sentence or a generation rule for the search term sequence on the basis of the history information so as to improve efficiency and accuracy of factuality verification processing.

### Supplementary 3

The system according to supplementary 1,
wherein the processor is configured to accept, via a user operation screen on the display device, a user selection of at least a part of the information requiring verification of factuality, receive, on the basis of the selection, an instruction to change a search condition or content of the prompt sentence, and execute an interactive verification process including re-executing the information retrieval and re-generating the summary information on the basis of the changed search condition or the changed prompt sentence.

### Application Example 2

### Supplementary 1

A system comprising a processor,
wherein the processor is configured to
acquire character information provided via an information medium,
preprocess the acquired character information by segmenting the character information into sentence units and word units and by assigning part-of-speech information and semantic information so as to structure the character information as a symbol sequence,
generate a prompt sentence that defines processing contents and an output format for extracting descriptions requiring fact checking, based on the structured character information, input the generated prompt sentence and the character information to a generative artificial intelligence model that performs natural language processing, and obtain, from the generative artificial intelligence model, an extraction result including candidate descriptions requiring fact checking,
for each candidate description included in the extraction result, extract named expressions, quantity expressions, and time expressions, determine consistency with corresponding portions in the character information, identify descriptions requiring fact checking, and organize the identified descriptions as normalized fact information,
generate a search query including a search term sequence or an interrogative-type search expression for verifying the normalized fact information, based on the normalized fact information,
transmit a search request including the search query to an information retrieval platform and acquire a search result from an external information source,
calculate a relevance score for the acquired search result based on similarity information, reliability information, and time information, and generate, for each piece of the normalized fact information, summary information indicating a degree of support, contradiction, or neutrality,
calculate, based on emotional input information acquired from a user, a priority for each piece of the normalized fact information, and control at least one of a presentation order and a degree of emphasis of the summary information and the search result according to the priority, and
present the summary information and the search result in a format that is easy for the user to understand, via a display unit of a user terminal.

### Supplementary 2

The system according to supplementary 1,
wherein the processor is configured to, when generating the prompt sentence, add metadata including context information, named expression information, and quantity information extracted from the structured character information, and specify a description style of the prompt sentence such that a machine-readable structured output is obtainable from the generative artificial intelligence model.

### Supplementary 3

The system according to supplementary 1,
wherein the processor is configured to analyze character input or voice input acquired from the user terminal to identify an emotional state, and, according to the identified emotional state, adjust at least one of a target range of extraction processing of the descriptions requiring fact checking, a specificity level of the search query, and explanatory contents of the search result.

What is claimed is:

1. A system comprising:
circuitry configured to:
receive, via a packet-switched network, a data object comprising a sequence of natural-language tokens posted to an electronic platform;
generate, based on the received data object, an instruction sequence that directs a generative model to identify, within the sequence of natural-language tokens, one or more token subsequences representing assertions amenable to verification;
provide the instruction sequence to the generative model and obtain, from the generative model, an extraction output indicating the one or more token subsequences;
construct, for each indicated token subsequence, a query representation derived from the extraction output;
transmit the query representation to an information retrieval system via the packet-switched network and receive, from the information retrieval system, a result set comprising one or more retrieved data records;
generate structured display data that associates each indicated token subsequence with corresponding retrieved data records from the result set; and
cause the structured display data to be presented via an interface coupled to the circuitry.

2. The system according to claim 1, wherein the circuitry is configured to apply a transformer-based contextual embedding model to the sequence of natural-language tokens to produce token-level embedding vectors, and to apply a classification layer to the token-level embedding vectors to compute a score for each token subsequence indicating a likelihood that the token subsequence represents an assertion amenable to verification.

3. The system according to claim 2, wherein the circuitry is configured to compare each computed score against a threshold value and to select, as the one or more token subsequences, only those token subsequences for which the computed score exceeds the threshold value.

4. The system according to claim 3, wherein the circuitry is configured to extract, from each selected token subsequence, at least one of a named entity, a quantity expression, and a temporal expression, and to generate the query representation by combining the extracted named entity, quantity expression, or temporal expression into an ordered search term sequence.

5. The system according to claim 1, wherein the circuitry is configured to generate the instruction sequence by inserting the data object or a portion thereof into a template that specifies a task description, output constraints, and a structured output format expected from the generative model.

6. The system according to claim 1, wherein the circuitry is configured to compute a relevance score for each retrieved data record by determining a similarity measure between an embedding of the indicated token subsequence and an embedding of a content portion of the retrieved data record, and to rank the retrieved data records within the result set according to the computed relevance scores.

7. The system according to claim 6, wherein the relevance score further incorporates at least one of a source reliability metric and a temporal proximity metric derived from metadata of the retrieved data record.

8. The system according to claim 1, wherein the circuitry is configured to generate a further instruction sequence that includes the indicated token subsequence and at least a portion of the result set, to provide the further instruction sequence to the generative model, and to obtain, from the generative model, summary data indicating whether the result set supports, contradicts, or is inconclusive with respect to the indicated token subsequence.

9. The system according to claim 8, wherein the structured display data further comprises the summary data associated with each indicated token subsequence.

10. The system according to claim 1, wherein the circuitry is configured to receive, via the interface, an evaluation signal associated with a particular indicated token subsequence and a particular retrieved data record, and to store the evaluation signal in association with identification data linking the particular indicated token subsequence to the particular retrieved data record.

11. The system according to claim 10, wherein the circuitry is configured to use stored evaluation signals as training data to update at least one of the classification layer, a ranking function applied to the result set, and parameters of the generative model.

12. The system according to claim 1, wherein the circuitry is configured to perform natural-language preprocessing on the data object, the natural-language preprocessing comprising segmenting the sequence of natural-language tokens into sentence-level units, assigning part-of-speech labels to the tokens, and identifying dependency relations among the tokens.

13. The system according to claim 12, wherein the circuitry is configured to use the assigned part-of-speech labels and the identified dependency relations in combination with the extraction output from the generative model to refine identification of the one or more token subsequences.

14. The system according to claim 1, wherein the structured display data comprises, for each indicated token subsequence, position information specifying a location of the token subsequence within the data object, and wherein the circuitry is configured to cause the interface to render a visual indicator at the specified location.

15. The system according to claim 14, wherein the circuitry is configured to cause the interface to render, in association with the visual indicator, a selectable element that, upon activation, expands to display the corresponding retrieved data records.

16. The system according to claim 1, wherein the circuitry is configured to generate a corrective instruction sequence that includes the indicated token subsequence and verified data derived from the result set, to provide the corrective instruction sequence to the generative model, and to obtain, from the generative model, a corrected token subsequence that replaces an inaccurate portion of the indicated token subsequence with the verified data.

17. The system according to claim 1, wherein the circuitry is configured to receive emotional input data from a user, to analyze the emotional input data to determine an emotional state label, to calculate a priority value for each indicated token subsequence based on the emotional state label, and to adjust at least one of a presentation order and a visual emphasis of the structured display data according to the calculated priority values.

18. A system comprising:
circuitry configured to:
receive, via a packet-switched network, a data object comprising a sequence of natural-language tokens posted to an electronic platform;
apply a contextual embedding model to the sequence of natural-language tokens to produce embedding vectors;
apply a classification function to the embedding vectors to identify one or more token subsequences representing assertions amenable to verification;
generate an instruction sequence for a generative model based on the identified one or more token subsequences;
provide the instruction sequence to the generative model and obtain structured extraction data comprising attribute fields for each identified token subsequence;
construct a query representation from the attribute fields and transmit the query representation to an information retrieval system via the packet-switched network;
receive, from the information retrieval system, a result set;
compute a relevance score for each element of the result set based on at least a similarity measure between embeddings of the identified token subsequence and embeddings of the element;
generate structured display data that associates each identified token subsequence with relevance-ranked elements of the result set; and
cause the structured display data to be presented via an interface coupled to the circuitry.

19. The system according to claim 18, wherein the attribute fields comprise at least one of an event descriptor, a geographic identifier, a temporal indicator, and a quantity value, and wherein constructing the query representation comprises selecting terms from the attribute fields and ordering the selected terms according to a weighting function.

20. A method performed by circuitry, the method comprising:
receiving, via a packet-switched network, a data object comprising a sequence of natural-language tokens posted to an electronic platform;
generating an instruction sequence that directs a generative model to identify, within the sequence of natural-language tokens, one or more token subsequences representing assertions amenable to verification;
providing the instruction sequence to the generative model and obtaining an extraction output indicating the one or more token subsequences;
constructing, for each indicated token subsequence, a query representation derived from the extraction output;
transmitting the query representation to an information retrieval system via the packet-switched network and receiving a result set comprising one or more retrieved data records;
generating structured display data that associates each indicated token subsequence with corresponding retrieved data records; and
causing the structured display data to be presented via an interface coupled to the circuitry.
